(19) United States
(12) Patent Application Publication
(10) Pub. No.: US 2006/0098854 A1
(43) Pub. Date: May 11, 2006

(54) Abnormal pattern candidate detecting method and apparatus

(75) Inventor: Akira Oosawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/269,560

(22) Filed: Nov. 9, 2005

(30) Foreign Application Priority Data
Nov. 9, 2004 (JP) 325011/2004

(51) Int. Cl. G06K 9/00; G06K 9/46

(52) U.S. Cl. 382/128; 382/190

(57) ABSTRACT

At least part of abnormal pattern candidate detection processing is performed on an inputted image signal representing an adjustment image, which has been selected from a plurality of medical images. A predetermined processing parameter for the abnormal pattern candidate detection processing is set in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion.

### BACKGROUND OF THE INVENTION

1. Field of the Invention

This invention relates to a method, apparatus, and computer readable recording medium, on which a computer program has been recorded, for detecting abnormal pattern candidates embedded in medical images. This invention particularly relates to a method, apparatus, and computer readable recording medium, on which a computer program has been recorded, for detecting abnormal pattern candidates by use of detection levels having been set in accordance with conditions, such as image quality of the inputted medical images.

2. Description of the Related Art

In medical fields, computer aided diagnosis (CAD) systems for automatically detecting an abnormal pattern candidate embedded in an image, enhancing the detected abnormal pattern candidate, and displaying a visible image containing the enhanced abnormal pattern candidate have heretofore been known. Medical doctors view the visible image containing the abnormal pattern candidate having been detected with the CAD systems and make a final judgment as to whether the abnormal pattern candidate contained in the image is or is not a true abnormal pattern representing a diseased part, such as a tumor or a calcification.

As techniques for detecting an abnormal pattern candidate, for example, iris filtering techniques and morphological filtering techniques have heretofore been known. With their is filtering techniques, image processing with an iris filter is performed on a breast image, threshold value processing is performed on output values of the iris filter, and a candidate for a tumor pattern (a form of the abnormal pattern), which is a form of breast cancer, or the like, is thus detected automatically. With the morphological filtering techniques, image processing with a morphological filter is performed on a breast image, threshold value processing is performed on output values of the morphological filter, and a candidate for a microcalcification pattern (a form of the abnormal pattern), which is a different form of breast cancer, or the like, is thus detected automatically. (The iris filtering techniques and the morphological filtering techniques are described in, for example, Japanese Unexamined Patent Publication No. 8(1996)-294479.) Also, techniques utilizing subtraction processing have been known. With the techniques utilizing subtraction processing, a normal structure image corresponding to an inputted medical image is formed artificially, a subtraction image representing a difference between the inputted medical image and the normal structure image is formed, and a pattern having pixel values at least equal a predetermined value in the thus formed subtraction image is detected as an abnormal pattern candidate. The techniques utilizing subtraction processing are applied to, for example, medical images of the chests. (The techniques utilizing subtraction processing are described in, for example, U.S. Patent Application Publication No. 20030210813.

Conditions for recording medical images are not always kept at predetermined conditions. For example, it often occurs that the image recording conditions, such as a tube voltage, alter due to a change occurring with an image recording apparatus with the passage of time. Also, it often occurs that the image recording conditions are adjusted in accordance with preference of the medical doctor who views the medical image. Therefore, it may occur that the image quality of the medical images inputted to the CAD system varies for different image recording conditions. Heretofore, ordinarily, a processing parameter, such as a detection level (detection threshold value) for the abnormal pattern candidate, in the CAD system is set at an initial value having been previously obtained through experiments. Therefore, heretofore, the detection processing for the abnormal pattern candidate has not necessarily been performed under optimum parameter setting in accordance with the image recording conditions. For example, in cases of abnormal pattern candidate detection processing on a simple X-ray image of the chest, if the tube voltage at the time of the image recording operation becomes low, the contrast between a rib pattern and a soft tissue pattern will alter, and an image will be obtained, in which the rib pattern is conspicuous. Therefore, in cases where the detection processing is performed by use of an identical processing parameter, the result of detection of the abnormal pattern candidate varies for different image recording conditions for the inputted image. Accordingly, the problems have heretofore occurred with regard to diagnosis performance.

Therefore, the applicant proposed a technique for automatically setting a processing parameter for the CAD in accordance with a result of abnormal pattern candidate detection processing performed on an image of a reference phantom, such as a contrast-detail mammography (CDMAM) image, or a uniform exposure image having been recorded without an object. (The technique for automatically setting a processing parameter for the CAD is described in, for example, U.S. Patent Application Publication No. 20020041702.)

However, in order for the processing parameter for the CAD to be set with the technique described in U.S. Patent Application Publication No. 20020041702, it is necessary for the particular image recording operation, such as the operation for recording the reference phantom image or the uniform exposure image, to be performed in every case where the medical image is recorded, and therefore a considerable time and labor are required to perform the image recording operations. Also, since manual operations need be performed for the image recording, the setting of the processing parameter is not capable of being performed as a perfectly automatic operation.

### SUMMARY OF THE INVENTION

The primary object of the present invention is to provide an abnormal pattern candidate detecting method, wherein variation in result of detection of abnormal pattern candidates due to a difference of image recording conditions is capable of being suppressed, such that an image recorded with a particular technique need not be used and such that a manual operation need not be performed.

Another object of the present invention is to provide an apparatus for carrying out the abnormal pattern candidate detecting method.

A further object of the present invention is to provide a computer readable recording medium, on which a computer program for causing a computer to execute the abnormal pattern candidate detecting method has been recorded.

The present invention provides an abnormal pattern candidate detecting method, in which abnormal pattern candidate detection processing using a predetermined processing parameter is performed on each of inputted image signals representing a plurality of medical images of objects, and in which abnormal pattern candidates embedded in each of the medical images are thereby detected, the method comprising the steps of, before the abnormal pattern candidate detection processing on each of the inputted image signals representing the plurality of the medical images:

i) performing at least part of the abnormal pattern candidate detection processing on an inputted image signal representing an adjustment image, which has been selected from the plurality of the medical images, and

ii) setting the predetermined processing parameter in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion.

The present invention also provides an abnormal pattern candidate detecting apparatus, comprising:

i) abnormal pattern candidate detecting means for performing abnormal pattern candidate detection processing using a predetermined processing parameter on each of inputted image signals representing a plurality of medical images of objects, and thereby detecting abnormal pattern candidates embedded in each of the medical images,

ii) parameter setting means for:

performing at least part of the abnormal pattern candidate detection processing on an inputted image signal representing an adjustment image, which has been selected from the plurality of the medical images, and

setting the predetermined processing parameter in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion,

the abnormal pattern candidate detecting means performing the abnormal pattern candidate detection processing on each of the inputted image signals representing the plurality of the medical images and by use of the predetermined processing parameter, which has been set by the parameter setting means.

The present invention further provides a computer readable recording medium, on which a computer program for causing a computer to execute an abnormal pattern candidate detecting method has been recorded and from which the computer is capable of reading the computer program, the abnormal pattern candidate detecting method comprising performing abnormal pattern candidate detection processing using a predetermined processing parameter on each of inputted image signals representing a plurality of medical images of objects, and thereby detecting abnormal pattern candidates embedded in each of the medical images,

wherein the computer program comprises the procedures for, before the abnormal pattern candidate detection processing on each of the inputted image signals representing the plurality of the medical images:

i) performing at least part of the abnormal pattern candidate detection processing on an inputted image signal representing an adjustment image, which has been selected from the plurality of the medical images, and

ii) setting the predetermined processing parameter in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion.

A skilled artisan would know that the computer readable recording medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of the present invention. Additionally, computer code/instructions include, but are not limited to, source, object, and executable code and can be in any language including higher level languages, assembly language, and machine language.

The abnormal pattern candidate detecting method and apparatus and the computer readable recording medium in accordance with the present invention will further be illustrated hereinbelow.

Examples of the abnormal pattern candidate detection processing include the iris filtering processing, in which the image processing with the iris filter is performed, and in which the threshold value processing is performed on the output values of the iris filter (as described in Japanese Unexamined Patent Publication No. 8(1996)-294479). Examples of the abnormal pattern candidate detection processing also include the morphological filtering processing, in which the image processing with the morphological filter is performed, and in which the threshold value processing is performed on the output values of the morphological filter (as described in Japanese Unexamined Patent Publication No. 8(1996)-294479). Examples of the abnormal pattern candidate detection processing further include the subtraction processing, in which the subtraction image representing the difference between the inputted medical image and the normal structure image is formed, and in which the threshold value processing is performed on the pixel values of the subtraction image (as described in U.S. Patent Application Publication No. 20030210813). When necessary, the explanation will hereinbelow be made on the assumption that the abnormal pattern candidate detection processing comprises feature measure calculation processing, in which predetermined image processing is performed on the image signal representing the inputted image, and in which a feature measure representing the probability of a pattern being an abnormal pattern is thereby calculated with respect to each of pixels in the image or with respect to each of predetermined regions having been extracted from the image, and threshold value processing for judging that a region, which is associated with the feature measure at least equal to a predetermined detection threshold value, is an abnormal pattern candidate. Examples of the feature measures include a value, which is outputted from the aforesaid iris filtering processing, the difference operation processing, or the like, and an index value, which is calculated in accordance with the value outputted from the aforesaid iris filtering processing, the difference operation processing, or the like, and which represents the shape, the size, or the like, of each of the regions extracted from the image.

The term “predetermined processing parameter” as used herein means the parameter which varies the detection performance of the abnormal pattern candidate detection processing. Examples of the predetermined processing parameters include a coefficient in a mathematical formula, which is utilized in the image processing performed for the calculation of the feature measure, and the detection threshold value utilized in the threshold value processing.

The adjustment image is selected from the plurality of the medical images to be subjected to the abnormal pattern candidate detection processing. It is preferable that a plurality of adjustment images are selected from the plurality of the medical images to be subjected to the abnormal pattern candidate detection processing. Also, an index value may be calculated for each of the plurality of the selected adjustment images, the adjustment images associated with the index values, which markedly vary from the index values of the other adjustment images (e.g., such that the differences from an average value of the index values of the other adjustment images are larger than a predetermined reference value), may be eliminated, and the remaining adjustment images may be utilized for the setting of the predetermined processing parameter.

Examples of the results of the at least part of the abnormal pattern candidate detection processing include the information representing the position, the size, and the feature measure of each of the regions having been judged as being the abnormal pattern candidates, which information is obtained from the entire abnormal pattern candidate detection processing, and the information representing the feature measure of each pixel or each region in the image, which information is obtained from part of the abnormal pattern candidate detection processing.

Also, the at least part of the abnormal pattern candidate detection processing may be performed on the entire area of the adjustment image. Alternatively, the at least part of the abnormal pattern candidate detection processing may be performed on only a certain area of the adjustment image, such as a specific structure area or an area of interest in the image.

By way of example, the predetermined criterion may be a criterion having been set such that the number of the abnormal pattern candidates, which are detected from the adjustment image, coincides with an average number of false positives per image, the average number of false positives per image having been obtained in cases where the predetermined processing parameter is set such that a true positive detection rate desired by a person, who views a displayed image, is acquired in the abnormal pattern candidate detection processing performed on inputted image signals representing a plurality of teacher images, in which the regions of abnormal patterns have been specified previously. It will be ideal that all of the abnormal pattern candidates having been detected with the abnormal pattern candidate detection processing are true abnormal areas. However, actually, the abnormal pattern candidates having been detected with the abnormal pattern candidate detection processing contain true positives (TP's), which are true abnormal patterns, and false positives (FP's), which are normal patterns having been detected by mistake as the abnormal patterns. The aforesaid criterion taken as an example of the predetermined criterion is based upon such findings. The term “true positive detection rate” as used herein means the rate of the abnormal patterns, which have been detected with the abnormal pattern candidate detection processing, with respect to all of the true abnormal patterns embedded in the image. The term “average number of false positives per image” as used herein means the averaged number of the false positives per image, which have been detected in cases where the abnormal pattern candidate detection processing is performed by use of the predetermined processing parameter having been set such that the true positive detection rate is capable of being acquired.

Examples of the processing for setting the predetermined processing parameter will be described hereinbelow.

(1) The detection threshold value (the processing parameter) is set such that the number of the abnormal pattern candidates, which are detected from an entire area of the adjustment image or a specific area of interest in the adjustment image, coincides with the average number of false positives per image.

(2) A value obtained from a calculation, in which an average value of a feature measure having been calculated with respect to an entire area of the adjustment image or a specific area of interest in the adjustment image is multiplied by a predetermined ratio, is set as the detection threshold value (the processing parameter). The predetermined ratio is the radio of the detection threshold value to the average value of the feature measure having been calculated from the inputted image signals representing the plurality of the teacher images in cases where the abnormal pattern candidates are detected with the predetermined processing parameter being set such that the true positive detection rate desired by the person, who views a displayed image, is acquired in the abnormal pattern candidate detection processing performed on the inputted image signals representing the plurality of the teacher images, in which the regions of abnormal patterns have been specified previously. In this manner, the detection threshold value is capable of being set such that the number of the abnormal pattern candidates, which are detected with the abnormal pattern candidate detection processing performed on the inputted image signal representing the adjustment image, coincides with the average number of false positives per image, the average number of false positives per image having been obtained in cases where the predetermined processing parameter is set such that the true positive detection rate desired by the person, who views a displayed image, is acquired in the abnormal pattern candidate detection processing performed on the inputted image signals representing the plurality of the teacher images, in which the regions of abnormal patterns have been specified previously.

(3) A coefficient (the processing parameter) of a mathematical formula is set such that an average value of a feature measure having been calculated with respect to an entire area of the adjustment image or a specific area of interest in the adjustment image coincides with the average value of the feature measure having been calculated in cases where the coefficient (the processing parameter) of the mathematical formula is set such that a true positive detection rate desired by a person, who views a displayed image, is acquired in the abnormal pattern candidate detection processing performed on inputted image signals representing a plurality of teacher images, in which the regions of abnormal patterns have been specified previously. In this manner, the distribution range of the feature measure subjected to the threshold value processing contained in the abnormal pattern candidate detection processing is capable of being set to be identical between the adjustment image and the teacher images. Therefore, the aforesaid setting of the coefficient (the processing parameter) of the mathematical formula becomes equivalent to the setting of the coefficient (the processing parameter) of the mathematical formula such that the number of the abnormal pattern candidates, which are detected with the abnormal pattern candidate detection processing performed on the inputted image signal representing the adjustment image, coincides with the average number of false positives per image, the average number of false positives per image having been obtained in cases where the predetermined processing parameter is set such that the true positive detection rate desired by the person, who views a displayed image, is acquired in the abnormal pattern candidate detection processing performed on the inputted image signals representing the plurality of the teacher images, in which the regions of abnormal patterns have been specified previously.

The teacher images may be obtained from the recording of the images of the objects or the recording of the images of phantoms, such as human body models.

In cases where the objects are the chests of human bodies, processing for recognizing rib patterns embedded in the adjustment image may be performed, at least part of the processing for detecting the abnormal pattern candidates at least at the intersecting areas of the rib patterns having been recognized may be performed, and the predetermined processing parameter may be set in accordance with the results of the at least part of the processing for detecting the abnormal pattern candidates such that the number of the abnormal pattern candidates detected at the intersecting areas of the rib patterns satisfies the predetermined criterion. As for each of the intersecting areas of the rib patterns, the shape, the characteristics of gradients of pixel values, and the like, are approximately identical with those of an abnormal pattern area. Therefore, each of the intersecting areas of the rib patterns is apt to be detected by mistake as an abnormal pattern candidate. Accordingly, the abnormal pattern candidates detected at the intersecting areas of the rib patterns may be regarded as false positives. Also, the predetermined criterion may be a criterion having been set such that the number of the abnormal pattern candidates, which are detected at the intersecting areas of the rib patterns, coincides with the number of the abnormal pattern candidates (or the average number of false positives per image) having been detected at the intersecting areas of the rib patterns in cases where the predetermined processing parameter is set such that a true positive detection rate desired by a person, who views a displayed image, is acquired in the abnormal pattern candidate detection processing performed on inputted image signals representing a plurality of teacher images, in which the regions of abnormal patterns have been specified previously.

With each of the abnormal pattern candidate detecting method and apparatus and the computer readable recording medium in accordance with the present invention, the at least part of the abnormal pattern candidate detection processing is performed on the inputted image signal representing the adjustment image, which has been selected from the plurality of the medical images to be subjected to the abnormal pattern candidate detection processing. Also, the predetermined processing parameter for use in the abnormal pattern candidate detection processing is set in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies the predetermined criterion. Therefore, the processing parameter is capable of being set automatically, and the abnormal pattern candidate detection processing is capable of being performed by use of the set processing parameter on each of the image signals representing the plurality of the medical images to be subjected to the abnormal pattern candidate detection processing. Accordingly, variation in result of detection of abnormal pattern candidates due to a difference of image recording conditions is capable of being suppressed, such that an image recorded with a particular technique need not be used. As a result, the reliability of the detection performance of the abnormal pattern candidate detection processing is capable of being enhanced.

In cases where the plurality of the adjustment images are selected, adverse effects of particularity of the adjustment image, which particularity arises with respect to the plurality of the medical images to be subjected to the abnormal pattern candidate detection processing, upon the setting of the processing parameter are capable of being suppressed. Therefore, the setting of the processing parameter is capable of being performed more appropriately.

Also, since a manual operation for particular image recording, or the like, need not be performed, and since the setting of the processing parameter is thus capable of being performed perfectly automatically, the operation efficiency of the abnormal pattern candidate detecting apparatus is capable of being enhanced.

In cases where the objects are the chests of human bodies, the at least part of the abnormal pattern candidate detection processing may be performed on only the intersecting areas of the rib patterns in the adjustment image, and the processing parameter may be set in accordance with the results of the at least part of the abnormal pattern candidate detection processing. In such cases, since the intersecting areas of the rib patterns are apt to be detected as false positives, and since the possibility of true abnormal patterns being located at the intersecting area of the rib patterns is lower than the possibility of true abnormal patterns being located in the entire area of the image, the setting of the processing parameter is capable of being performed more appropriately under more regulated conditions than the cases where the setting of the processing parameter is performed by use of the entire area of the adjustment image.

### BRIEF DESCRIPTION OF THE DRAWINGS

FIG. 1 is a block diagram showing a constitution and a processing flow in a first embodiment of the abnormal pattern candidate detecting apparatus in accordance with the present invention,

FIG. 2A is an explanatory view showing a mask, which has its center at a pixel j and has a size of 5 pixels (along a column direction)×5 pixels (along a row direction),

FIG. 2B is an explanatory view showing an orientation of a gradient vector at the pixel j,

FIG. 3 is an explanatory view showing how a degree of convergence is calculated,

FIG. 4 is an explanatory view showing an adaptive ring filter,

FIGS. 5A, 5B, and 5C are explanatory views showing how pixel values are outputted from the adaptive ring filter,

FIGS. 6A and 6B are explanatory views showing an example of how an output image is obtained from the adaptive ring filter,

FIG. 7 is an explanatory view showing an example of division of a thorax image,

FIGS. 8A and 8B are explanatory views showing how an output image is obtained from adaptive ring filtering processing performed on an original image,

FIGS. 8C and 8D are explanatory views showing how an output image is obtained from adaptive ring filtering processing performed on a difference image,

FIGS. 9A, 9B, 9C, and 9D are explanatory views showing how binary images are obtained in cases where a threshold value is altered,

FIG. 10 is an explanatory view showing a radius and a circularity of an isolated region,

FIG. 11 is a graph showing an example of a free-response receiver operating characteristic curve representing a relationship between a true positive detection rate and an average number of false positives per image in abnormal pattern candidate detection processing,

FIG. 12 is a block diagram showing a constitution and a processing flow in a second embodiment of the abnormal pattern candidate detecting apparatus in accordance with the present invention,

FIGS. 13A, 13B, 13C, and 13D are explanatory views showing how rib patterns are recognized with principal constituent analysis,

FIG. 14 is an explanatory view showing how a shape of a rib pattern is extracted by use of a B spline curve,

FIG. 15 is an explanatory view showing control points of the B spline curve,

FIG. 16 is an explanatory view showing how certain areas are judged as being the intersecting areas of rib patterns,

FIG. 17 is a block diagram showing a constitution and a processing flow in a third embodiment of the abnormal pattern candidate detecting apparatus in accordance with the present invention, and

FIG. 18 is a block diagram showing a constitution and a processing flow in a fourth embodiment of the abnormal pattern candidate detecting apparatus in accordance with the present invention.

### DESCRIPTION OF THE PREFERRED EMBODIMENTS

The present invention will hereinbelow be described in further detail with reference to the accompanying drawings.

Each of embodiments of the abnormal pattern candidate detecting apparatus in accordance with the present invention is adapted to detect candidates for abnormal patterns, such as tuber patterns, from simple X-ray images of the chests. Each of the embodiments of the abnormal pattern candidate detecting apparatus in accordance with the present invention is incorporated in an image processing server of a CAD system. The CAD system comprises the image processing server for performing various kinds of image processing on received image signals, which represent simple X-ray images of the chests and have been acquired with modalities, such as X-ray image recording apparatuses and CR apparatuses. The CAD system also comprises an image storage device for storing the image signals, which represent the images having been acquired with the modalities, and the image signals, which represent the images having been obtained from the image processing performed by the image processing server. The CAD system further comprises a viewer for displaying various kinds of images. The image processing server, the image storage device, and the viewer are connected with one another through a network, such as LAN or WAN.

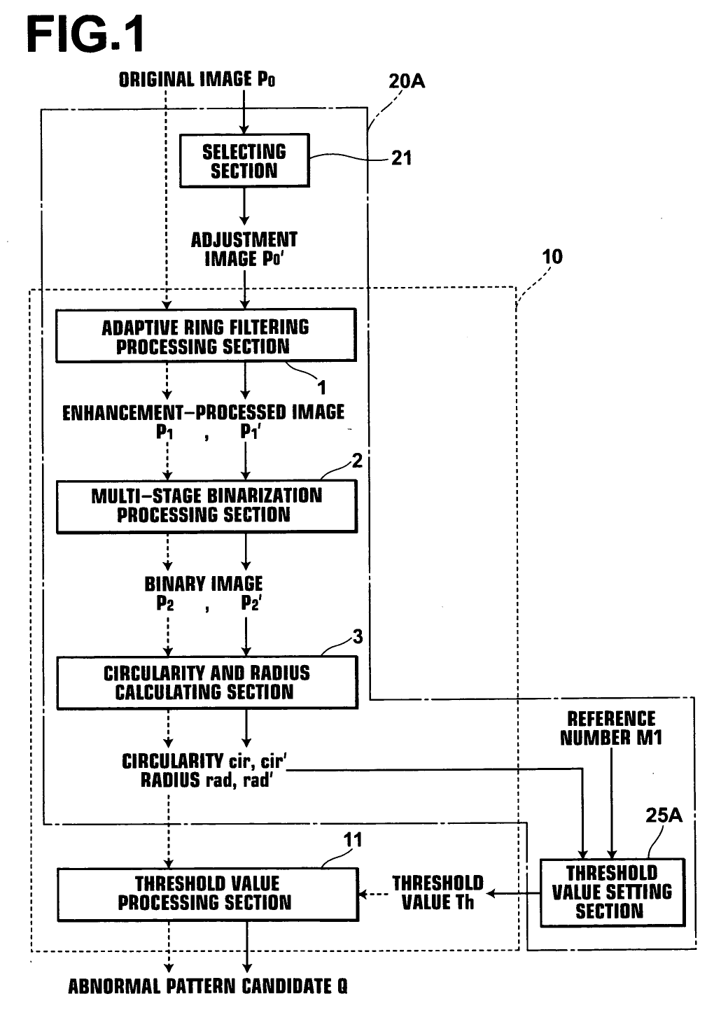

FIG. 1 is a block diagram showing a constitution and a processing flow in a first embodiment of the abnormal pattern candidate detecting apparatus in accordance with the present invention. With reference to FIG. 1, the first embodiment of the abnormal pattern candidate detecting apparatus in accordance with the present invention comprises an adaptive ring filtering processing section 1, a multi-stage binarization processing section 2, a circularity and radius calculating section 3, a threshold value processing section 11, a selecting section 21, and a threshold value setting section 25A. The adaptive ring filtering processing section 1 performs image processing with an adaptive ring filter on each of received original image signals P₀, P₀, . . . representing original images P₀, P₀, . . . or on each of adjustment image signals P₀′, P₀′, . . . representing adjustment images P₀′, P₀′, . . . (As an aid in facilitating the explanation, both the image and the image signal representing the image are herein numbered with the same reference numeral.) The adaptive ring filtering processing section 1 thus forms an enhancement-processed image P₁ or P₁′ obtained such that a region, in which gradient vectors of pixel values converge, has been enhanced. The multi-stage binarization processing section 2 performs binarization processing with a plurality of different threshold values on the enhancement-processed image P₁ or P₁′ and forms a plurality of binary images P₂, P₂, . . . or a plurality of binary images P₂′, P₂′, . . . respectively corresponding to the different threshold values. The circularity and radius calculating section 3 calculates a circularity cir or cir′ and a radius rad or rad′ of a region (hereinbelow referred to as the isolated region) in each of the binary images P₂, P₂, . . . or in each of the binary images P₂′, P₂′, . . . , in which region the pixels having pixel values larger than the given threshold value are joined together. The threshold value processing section 11 performs threshold value processing on each of the circularity cir and the radius rad by use of the corresponding threshold value Th having been determined and detects an isolated region, which satisfies the conditions with the predetermined threshold value Th, as an abnormal pattern candidate Q. The selecting section 21 selects the plurality of the adjustment images P₀′, P₀′, . . . at random from the original images P₀, P₀, . . . The threshold value setting section 25A sets the threshold value Th, which is to be used in the threshold value processing section 11, in accordance with the circularity cir′ and the radius rad′, which have been calculated with respect to each of the adjustment image signals P₀′, P₀′, . . . , and in accordance with an average number of false positives per image (reference number) M₁, the average number of false positives per image having been obtained in cases where the threshold value Th is set such that a true positive detection rate desired by a person, who views a displayed image, is acquired in the abnormal pattern candidate detection processing performed on inputted image signals representing a plurality of teacher images, in which the regions of abnormal patterns have been specified previously. The adaptive ring filtering processing section 1, the multi-stage binarization processing section 2, the circularity and radius calculating section 3, and the threshold value processing section 11 together constitute abnormal pattern candidate detecting means 10. Also, the selecting section 21, the adaptive ring filtering processing section 1, the multi-stage binarization processing section 2, the circularity and radius calculating section 3, and the threshold value setting section 25A together constitute parameter setting means 20A.

The functions of each of the processing sections described above are achieved by the execution of sub-programs for executing the processing. Also, the functions of the abnormal pattern candidate detecting apparatus in accordance with the present invention are achieved by the execution of a main program for controlling the order of the execution of the sub-programs. The sub-programs for the adaptive ring filtering processing section 1, the multi-stage binarization processing section 2, and the circularity and radius calculating section 3 are executed as the sub-programs common to the abnormal pattern candidate detecting means 10 and the parameter setting means 20A.

How the processing in each of the processing sections is performed will hereinbelow be described in detail.

The adaptive ring filtering processing section 1 performs the enhancement processing on each of the inputted radiation images by use of the adaptive ring filter in order to enhance the region, which may become the candidate for the abnormal pattern, such as the tuber pattern. The adaptive ring filtering processing section 1 thus outputs the enhancement-processed image. In the image, the abnormal pattern, such as the tuber pattern or a tumor pattern, appears as a circular convex region, which has an approximately round contour, which has larger pixel values (smaller image density values) than surrounding areas, and which has a hemispherical shape such that pixels having an identical image density spread in a concentric circle form. Specifically, in the circular convex region, the pixel values (the image density values) are distributed such that the pixel values become large (i.e., the image density values become small) from a peripheral area toward a center area, and gradients of the pixel values are thus found. Gradient lines representing the gradients converge toward the center point of the circular convex region. Therefore, the adaptive ring filtering processing section 1 calculates the gradients of the pixel values in the inputted radiation image as gradient vectors and calculates a degree of convergence of the gradient vectors. Also, the adaptive ring filtering processing section 1 performs the enhancement processing in accordance with the degree of convergence of the gradient vectors and outputs the enhancement-processed image, in which the circular convex region, i.e. the region having the possibility of being the abnormal pattern candidate, has been enhanced.

As for certain abnormal patterns, such as tuber patterns, it may often occur that the pixel values do not monotonously become small from the center area toward the periphery, a vector field is disturbed, and the degree of convergence of the gradient vectors becomes low. The adaptive ring filter is capable of being applied to both the cases, where the pixel values alter monotonously, and the cases, where the pixel values at the center area are not monotonous, where the vector field is disturbed, and where the degree of convergence of the gradient vectors becomes low.

The processing will hereinbelow be described in more detail.

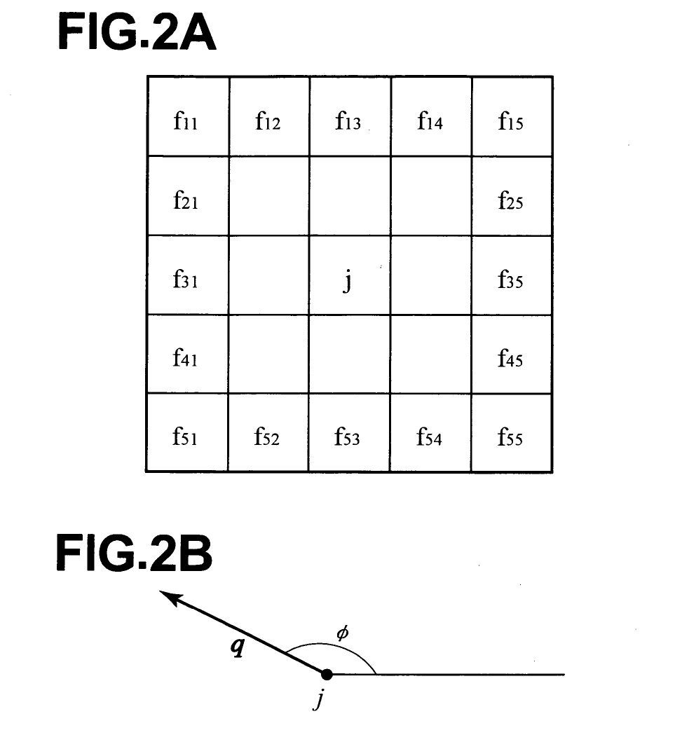

Firstly, for each pixel j among all of the pixels constituting a given image, an orientation φ of the gradient vector is calculated with Formula (1) shown below. As illustrated in FIG. 2, f₁₁ through f₅₅ in Formula (1) represent the pixel values corresponding to the pixels located at the peripheral areas of a mask, which has a size of five pixels (located along the column direction of the pixel array)×five pixels (located along the row direction of the pixel array) and which has its center at the pixel j.

$$ϕ = {tan}^{- 1} \frac{( {f}_{11} + {f}_{12} + {f}_{13} + {f}_{14} + {f}_{15} ) - ( {f}_{51} + {f}_{52} + {f}_{53} + {f}_{54} + {f}_{55} )}{( {f}_{15} + {f}_{25} + {f}_{35} + {f}_{45} + {f}_{55} ) - ( {f}_{11} + {f}_{21} + {f}_{31} + {f}_{41} + {f}_{51} )} \qquad ( 1 )$$

Thereafter, for every pixel i among all of the pixels constituting the given image, the pixel i is taken as a pixel of interest, and a degree of convergence cᵢ of the gradient vectors with respect to the pixel of interest i is calculated with Formula (2) shown below. As illustrated in FIG. 3, in Formula (2), N represents the number of the pixels located in the region inside of a circle, which has its center at the pixel of interest i and has a radius l, and θⱼ represents the angle made between the straight line, which connects the pixel of interest i and each pixel j located in the circle, and the gradient vector at the pixel j, which gradient vector has been calculated with Formula (1).

$${c}_{i} = ( 1 / N ) {\sum }_{j = 1}^{N} cos {θ}_{j} \qquad ( 2 )$$

In cases where the orientations of the gradient vectors of the respective pixels j converge toward the pixel of interest i, the degree of convergence cᵢ represented by Formula (2) takes a large value. In the cases of the circular convex region having the possibility of being an abnormal pattern candidate, the gradient vector of each pixel j, which is located at the peripheral area, is directed approximately to the center area of the region regardless of the level of the contrast of the pattern. Therefore, the pixel of interest associated with the degree of convergence cᵢ, which takes a large value, is the pixel located at the center area of the circular convex region.

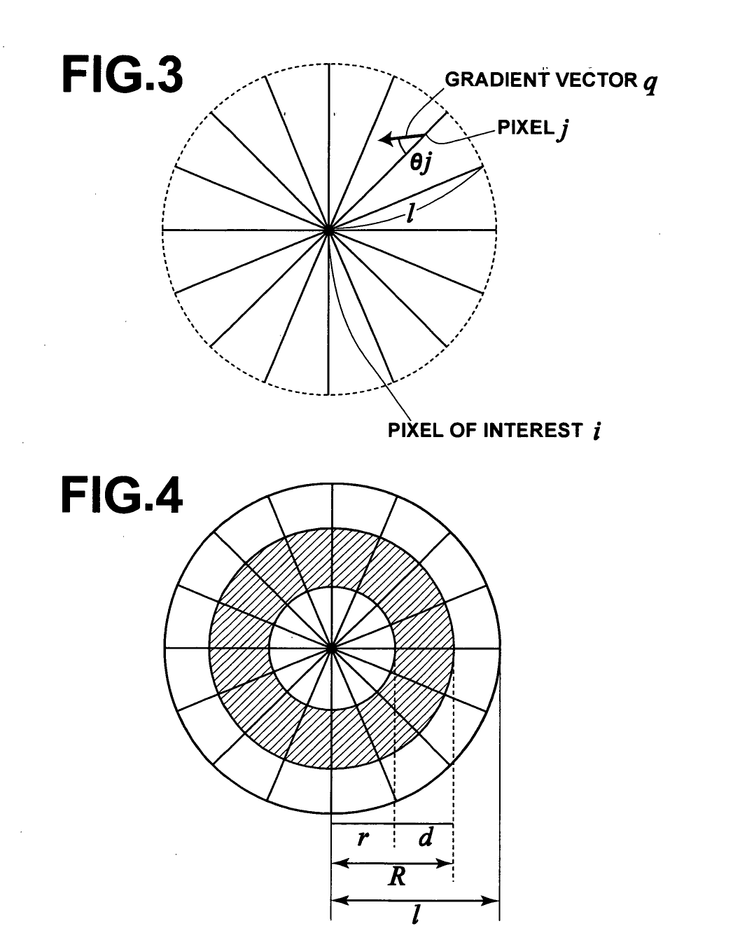

Thereafter, with respect to each pixel, an output value C of the adaptive ring filter is calculated with Formula (3) shown below in accordance with the calculated degree of convergence cᵢ. The adaptive ring filter is set such that a ring-shaped region, which is hatched in FIG. 4, acts are a masking region. A radius r of an inside circle and a radius R of an outside circle have the relationship R=r+d, where d represents the predetermined number representing the width of the ring. The radius r of the inside circle is determined in an adaptive manner.

$$C ( x , y ) = {max}_{0 \leq r \leq l - d} \frac{1}{N} {\sum }_{i = 0}^{N - 1} {c}_{i} \\ where \\ {c}_{i} = \frac{1}{d} {\sum }_{j = r + 1}^{R} cos {θ}_{j} \qquad ( 3 )$$

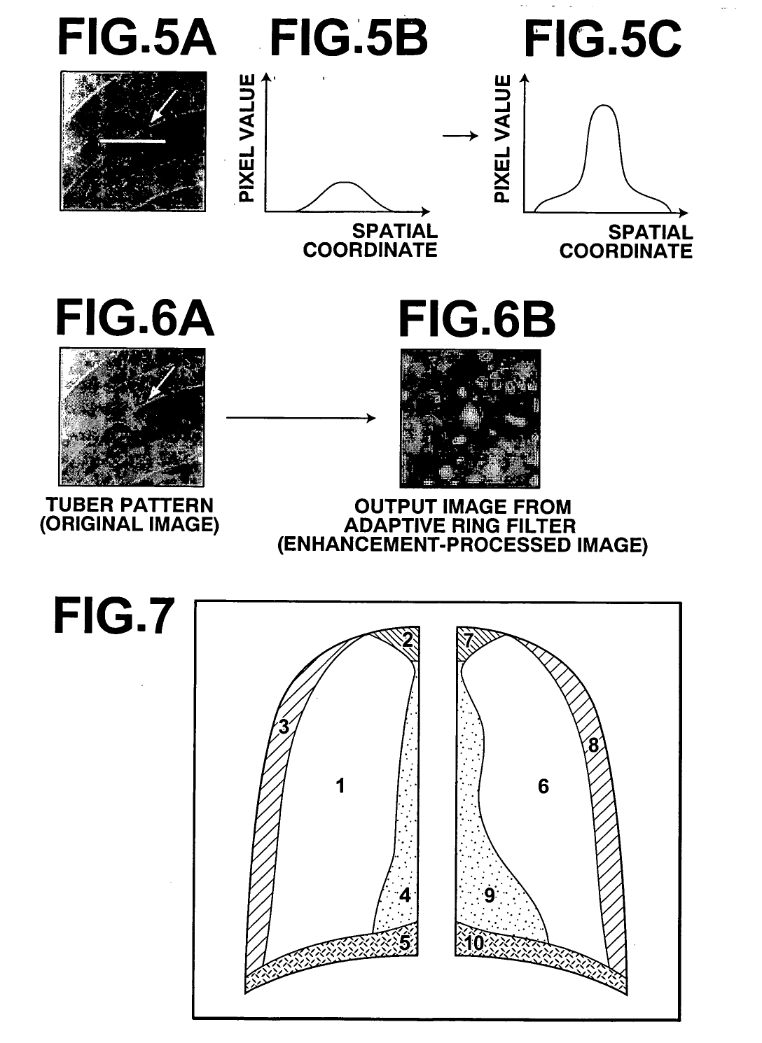

The output value C of the adaptive ring filter takes a maximal value in the vicinity of the center point of the circular convex region. For example, a circular convex region embedded in an image illustrated in FIG. 5A has pixel values illustrated in FIG. 5B on the white line. As illustrated in FIG. 5C, in cases where the image processing with the adaptive ring filter is performed, pixel values larger than the pixel values of the original image appear at the center area. FIGS. 6A and 6B show an example, in which a tuber area is enhanced by use of an adaptive ring filter having been set such that l=20 mm, and d=4 mm. In cases where the adaptive ring filtering processing is performed on the original image illustrated in FIG. 6A, the tuber area (indicated by the white arrow) in the original image is enhanced as illustrated in FIG. 6B. (The enhancement is described in, for example, “Convergence Index Filter for Detection of Lung Nodule Candidates” by Jun Wei, et al., IEICE, Vol. J83-D-II, No. 1, pp. 118-125, January 2000.)

However, in cases where the adaptive ring filtering processing is performed on the simple X-ray image of the chest, since rib patterns, and the like, overlap at peripheral areas of the thorax image, the degree of convergence of the image density gradients becomes disturbed, and the circular convex region is not capable of being enhanced appropriately. Therefore, as for the peripheral areas of the thorax image, the enhancement processing should preferably be performed after removal of adverse effects of the background image.

For example, as proposed by the applicant in Japanese Unexamined Patent Publication No. 2003-6661, the thorax image may be extracted and divided as illustrated in FIG. 7 into pulmonary apex areas (areas 2 and 7), peripheral areas (areas 3 and 8), mediastinum areas (areas 4 and 9), and under-diaphragm areas (areas 5 and 10), and the peripheral areas may thereby be extracted. Also, with respect to the obtained peripheral areas (areas 3 and 8), a difference image, in which the background image has been subtracted from the original image, maybe formed. Further, the enhancement processing may be performed on the difference image. In this manner, the adverse effects of the background image are capable of being eliminated, and the tuber pattern is capable of being enhanced. Specifically, for example, a smoothed image may be formed with blurring of the original image by use of a Gaussian filter and subtracted from the original image, and the background image components may thus be removed.

Alternatively, by use of the technique proposed in U.S. Pat. No. 6,549,646, the thorax image may be divided into the pulmonary apex areas (the areas 2 and 7), the peripheral areas (the areas 3 and 8), the mediastinum areas (the areas 4 and 9), and the under-diaphragm areas (the areas 5 and 10), and the peripheral areas may thereby be extracted.

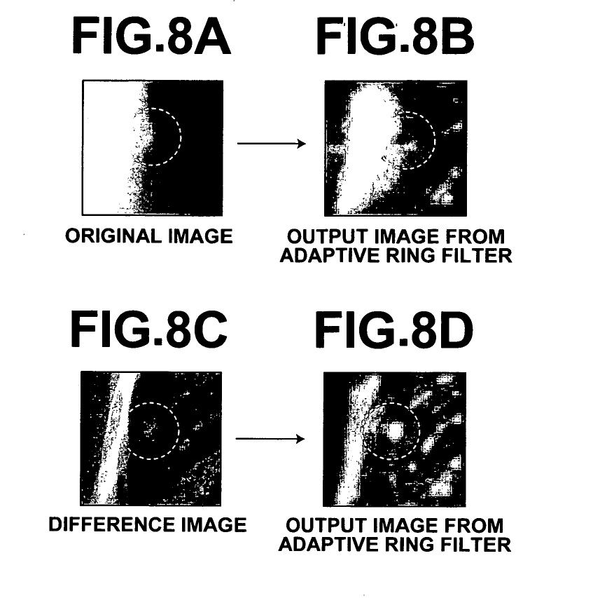

FIGS. 8A to 8D illustrate the effects of removal of the adverse effects of the background image upon the peripheral areas. FIGS. 8A and 8B are explanatory views showing how an enhancement-processed image is obtained from adaptive ring filtering processing performed on an original image. FIGS. 8C and 8D are explanatory views showing how an enhancement-processed image is obtained from adaptive ring filtering processing performed on a peripheral area in a difference image, which has been obtained with subtraction of a smoothed image from an original image. It is capable of being found that, in the cases of FIGS. 8C and 8D, the tuber pattern is enhanced appropriately without being affected by the background image.

The multi-stage binarization processing section 2 performs the binarization processing, in which the threshold value is altered little by little from a small value to a large value, on the inputted enhancement-processed image and outputs a plurality of binary images. With the binarization processing, the pixel value of a pixel, which has the pixel value larger than the given threshold value, is replaced by a first pixel value (e.g., 255 (white)), the pixel value of a pixel, which has the pixel value smaller than the given threshold value, is replaced by a second pixel value (e.g., 0 (black)), and the binary image is thus formed. In cases where the binarization processing is performed on the enhancement-processed image having been obtained from the adaptive ring filtering processing, the pixel values of a region, such as a structure pattern or a tuber pattern, in the image, which region has large pixel values, are replaced by the first pixel value, and the pixel values of the other regions are replaced by the second pixel value. The region, in which the pixels having the first pixel value are joined together, appears as an island-shaped isolated region in the binary image. In cases where the given threshold value is small, the isolated region appearing in the binary image contains a white cloud-like part, or the like, which appears in the background image. As the threshold value becomes large, only the region of the structure pattern or the tuber pattern, which region does not contain the background image, is extracted as the isolated region. Particularly, the circular convex region, which has been enhanced by use of the adaptive ring filter, has the pixel values larger than the pixel values of the other structure patterns and appears as the isolated region even in the binary image, which has been binarized with a large threshold value.

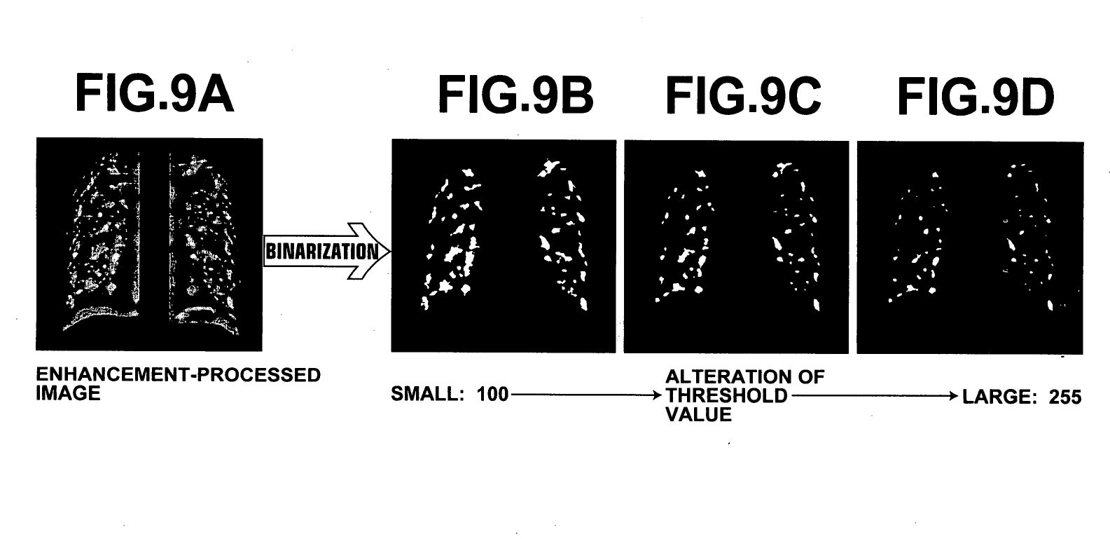

FIGS. 9A, 9B, 9C, and 9D are explanatory views showing how binary images are obtained in cases where a threshold value is altered. FIG. 9A shows the enhancement-processed image, in which the circular convex regions have been enhanced with the adaptive ring filtering processing performed on the original image. The enhancement-processed image has been quantized with 8 bits and has gradation with pixel values of 0 to 255. In cases where the binarization processing is performed on the enhancement-processed image with a pixel value of 100 being taken as the threshold value, the binary image illustrated in FIG. 9B is obtained, and the white isolated regions (whose pixel values have been replaced by the first pixel value) appear. FIG. 9C shows the binary image having been obtained from the binarization processing performed with a threshold value of 176. FIG. 9D shows the binary image having been obtained from the binarization processing performed with a threshold value of 252. In the multi-stage binarization processing section 2, the threshold value is altered at intervals of a pixel value of 4, and the binarization processing is performed in 39 stages on the inputted image having been quantized with 8 bits.

The circularity and radius calculating section 3 calculates the circularity and the radius of the isolated region in the binary image.

All of the isolated regions in the binary image having been formed by the multi-stage binarization processing section 2 do not necessarily have the possibility of being the abnormal pattern candidates. Certain isolated regions may contain structure patterns, or the like, and should be discriminated from the isolated regions having the possibility of being the abnormal pattern candidates. The abnormal patterns, such as the tuber patterns, have the characteristics such that the shape is close to a circle and such that the area is small. Also, the isolated regions, which have been extracted so as to contain the background image, and the isolated regions, in which structure patterns have been extracted, ordinarily have the characteristics such that the shape is different from a circle and such that the area is large. Therefore, in order for the abnormal pattern candidates and the other structure patterns, or the like, to be discriminated from each other, it is efficient that the calculations are made to find the circularity of each isolated region in the binary image, which circularity represents the degree of closeness to a circle having an identical area, and the radius representing the size of the isolated region.

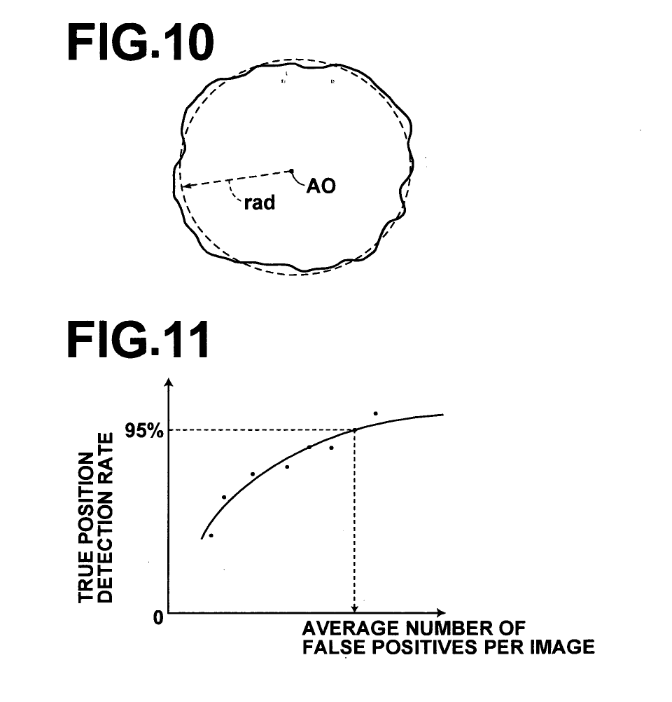

By way of example, the radius rad and the circularity cir are calculated from an area A and a circumferential length L of the isolated region, which has been extracted, in the manner described below. How the calculations are made will be described hereinbelow with reference to FIG. 10.

Firstly, the radius rad is approximately represented by a radius of a regular circle having the area A with Formula (4) shown below.
rad=\sqrt{A/π} (4)

Thereafter, the area A of the isolated region having been extracted (the region indicated by the solid line in FIG. 10) and a center of gravity AO on the isolated region are calculated, and a virtual circle (indicated by the broken line in FIG. 10) is set. The virtual circle has an area approximately equal to the area A of the isolated region, has its center at the position at which the center of gravity AO is located, and has the radius rad. Further, an occupation ratio of the isolated region, which is contained within the virtual circle, with respect to the area A is calculated as the circularity cir. Specifically, the circularity cir is calculated with Formula (5) shown below.

$$cir = \frac{{A}^{′}}{A} \qquad ( 5 )$$

wherein A′ represents the area of the overlapping region, at which the virtual circle and the isolated region overlap one upon the other.

The threshold value processing section 11 makes a comparison between each of the circularity cir and the radius rad of each isolated region and the corresponding threshold value Th having been determined. Also, the threshold value processing section 11 detects the isolated region, which has the circularity cir and the radius rad satisfying the conditions with the predetermined threshold value Th, as the abnormal pattern candidate Q.

The selecting section 21 selects the plurality of the images as the adjustment images P₀′, P₀′, . . . at random from the original images P₀, P₀, . . . , which are the plurality of the simple X-ray images of the chests to be subjected to the abnormal pattern candidate detection processing. For example, in cases where the images to be subjected to the abnormal pattern candidate detection processing are located in an order regardless of the possibility of containing the abnormal pattern candidates, a predetermined number of the images beginning from the first image may be selected as the adjustment images P₀′, P₀′, . . . Alternatively, the selecting section 21 may form random numbers and may set correspondence relationship between each of the random numbers and each of the images to be subjected to the abnormal pattern candidate detection processing. Also, the selecting section 21 may locate the images, which are to be subjected to the abnormal pattern candidate detection processing, in decreasing order of the values of the random numbers and may select a predetermined number of the images beginning from the first image among the thus located images, as the adjustment images P₀′, P₀′, . . . The number of the adjustment images P₀′, P₀′, . . . may be fixed at a number having been set previously. Alternatively, the number of the adjustment images P₀′, P₀′, . . . may be set at a number equal to a value obtained from multiplication of the number of the images, which are to be subjected to the abnormal pattern candidate detection processing, by a predetermined ratio.

The threshold value setting section 25A sets the threshold value Th, which is to be used in the threshold value processing section 11, in accordance with the circularity cir′ and the radius rad′, which have been calculated by the circularity and radius calculating section 3 with respect to each isolated region embedded in the binary image, such that a number of abnormal pattern candidates, which number is equal to the predetermined reference number M₁, may be detected for each image. The information representing the threshold value Th is stored in a memory of the threshold value setting section 25A.

Ordinarily, a plurality of isolated regions may be extracted from one binary image. Also, a plurality of binary images are formed with respect to one adjustment image. Further, as illustrated in FIGS. 5A, 5B, and 5C, the circular convex region having been enhanced with the adaptive ring filter has the characteristics such that the pixel values of the center area are larger than the pixel values of the center area of the identical circular convex region embedded in the original image. Therefore, the circular convex region often appears as the isolated region at identical positions in the plurality of the binary images having been formed by the multi-stage binarization processing section 2. Accordingly, the threshold value setting section 25A makes a judgment for each adjustment image (each enhancement-processed image) and as to the identity of the positions of the isolated regions and eliminates duplicate counting of the isolated regions located at the identical positions.

The reference number M₁ has been determined previously in the manner described below. The information representing the reference number M₁ has been stored previously in the memory of the image processing server.

(1) Approximately several hundreds of examples of the image signals representing the plurality of the teacher images, in which the regions of abnormal patterns have been specified previously, are prepared.

(2) The abnormal pattern candidate detection processing with the adaptive ring filtering processing section 1, the multi-stage binarization processing section 2, the circularity and radius calculating section 3, and the threshold value processing section 11 is performed on each of the inputted image signals representing the plurality of the teacher images. At this time, the processing with the threshold value processing section 11 is performed by use of a plurality of patterns of the threshold values Th.

(3) The ratio (the true positive detection rate) of the number of the abnormal pattern candidates, which have been detected correctly, to the number of true abnormal patterns and the number of the false positives per image, which have been detected by mistake, are calculated with respect to each of the inputted images and each of the patterns of the threshold values Th and plotted on a coordinate plane, which has a vertical axis representing the true positive detection rate and a horizontal axis representing the number of false positives per image. FIG. 11 shows a free-response receiver operating characteristic curve (FROC curve), which approximately represents a set of plotted points.

(4) The average number of false positives per image corresponding to a true positive detection rate of, for example, 95% is calculated in accordance with the curve illustrated in FIG. 11 and is taken as the reference number M₁.

As described above, the plurality of the adjustment images P₀′, P₀′, . . . are selected. Therefore, for example, the threshold value setting section 25A may set the threshold value Th such that M₁ number of abnormal pattern candidates are detected with respect to every adjustment image. Alternatively, the threshold value setting section 25A may set the threshold value Th such that M₁ number of abnormal pattern candidates are detected with respect to at least one adjustment image. As another alternative, the threshold value setting section 25A may set the threshold value Th such that the average value of the numbers of the abnormal pattern candidates detected from the respective adjustment images becomes equal to the M₁ number.

The flow of the processing performed with the first embodiment of the abnormal pattern candidate detecting apparatus in accordance with the present invention will be described hereinbelow with reference to FIG. 1.

Firstly, the parameter setting means 20A sets the threshold value Th, which is to be used for the detection of the abnormal pattern candidates from the original images P₀, P₀, . . . to be subjected to the abnormal pattern candidate detection processing. The setting of the threshold value Th is performed in the manner described below.

(1) The selecting section 21 receives the inputted original image signals P₀, P₀, . . . , each of which represents one of the simple X-ray images of the chests having been recorded in mass medical examinations, and the like. The selecting section 21 selects the plurality of the adjustment images P₀′, P₀′, . . . at random from the inputted original images P₀, P₀, . . . and outputs the adjustment image signals P₀′, P₀′,

(2) The adaptive ring filtering processing section 1 receives the plurality of the inputted adjustment image signals P₀′, P₀′, . . . having been Selected by the selecting section 21. The adaptive ring filtering processing section 1 performs the image processing with the adaptive ring filter with respect to each of the inputted images and outputs the enhancement-processed image signals P₁′, P₁′, . . . , each of which represents the enhancement-processed image corresponding to one of the adjustment images P₀′, P₀′, . . .

(3) The multi-stage binarization processing section 2 receives the inputted enhancement-processed image signals P₁′, P₁′, . . . , which have been formed by the adaptive ring filtering processing section 1. The multi-stage binarization processing section 2 performs the 39-stage binarization processing on each of the inputted images and outputs 39 kinds of the binary images P₂′, P₂′, . . . with respect to each of the enhancement-processed images P₁′, P₁′, . . .

(4) The circularity and radius calculating section 3 calculates the circularity cir′ and the radius rad′ with respect to each of the isolated regions, which are embedded in each of the binary images P₂′, P₂′, . . .

(5) In accordance with the circularity cir′ and the radius rad′ having been calculated with respect to each of the isolated regions, which are embedded in each of the binary images P₂′, P₂′, . . . , the threshold value setting section 25A calculates the threshold value Th for each of the circularity and the radius, such that the M₁ number of the abnormal pattern candidates are detected from one adjustment image P₀′. The information representing the threshold value Th is stored in the memory of the image processing server.

Thereafter, the abnormal pattern candidate detecting means 10 detects the abnormal pattern candidates from each of the original images P₀, P₀, . . . in the manner described below.

(6) The adaptive ring filtering processing section 1 receives each of the inputted original image signals P₀, P₀, . . . , each of which represents one of the simple X-ray images of the chests to be subjected to the abnormal pattern candidate detection processing. The adaptive ring filtering processing section 1 performs the image processing with the adaptive ring filter with respect to each of the inputted images and outputs the enhancement-processed image signals P₁, P₁, . . . , each of which represents the enhancement-processed image corresponding to one of the original images P₀, P₀, . . .

(7) The multi-stage binarization processing section 2 receives the inputted enhancement-processed image signals P₁, P₁, . . . , which have been formed by the adaptive ring filtering processing section 1. The multi-stage binarization processing section 2 performs the 39-stage binarization processing on each of the inputted images and outputs 39 kinds of the binary images P₂, P₂, . . . with respect to each of the enhancement-processed images P₁, P₁, . . .

(8) The circularity and radius calculating section 3 calculates the circularity cir and the radius rad with respect to each of the isolated regions, which are embedded in each of the binary images P₂, P₂, . . .

(9) In accordance with the circularity cir and the radius rad having been calculated with respect to each of the isolated regions, which are embedded in each of the binary images P₂, P₂, . . . , the threshold value processing section 11 detects an isolated region, which satisfies the conditions with the threshold value Th having been set by the threshold value setting section 25A (e.g., the conditions such that the circularity cir is higher than 0.7, and at the same time the radius rad falls within the range of 2.26 mm and 4.94 mm), as the abnormal pattern candidate Q.

As described above, with the first embodiment of the abnormal pattern candidate detecting apparatus in accordance with the present invention, before the processing with the abnormal pattern candidate detecting means 10 is performed, the parameter setting means 20A performs the at least part of the abnormal pattern candidate detection processing with the abnormal pattern candidate detecting means 10 and on the inputted adjustment image signals P₀′, P₀′, . . . representing the adjustment images having been selected at random from the plurality of the original images P₀, P₀, . . . , which are the simple X-ray images of the chests to be subjected to the abnormal pattern candidate detection processing. Also, the parameter setting means 20A automatically sets the detection threshold value Th for the abnormal pattern candidate detection processing in accordance with the circularity cir′ and the radius rad′ of each of the isolated regions in each binary image P₂′, the circularity cir′ and the radius rad′ having been obtained from the at least part of the abnormal pattern candidate detection processing having been performed on the inputted adjustment image signals P₀′, P₀′, . . . The setting of the detection threshold value Th is performed such that the number of the abnormal pattern candidates, which are detected with the abnormal pattern candidate detection processing performed on the inputted adjustment image signals P₀′, P₀′, . . . , coincides with the average number M₁ of false positives per image having been calculated previously. Further, by use of the threshold value Th having thus been set, the abnormal pattern candidate detecting means 10 performs the abnormal pattern candidate detection processing on each of the original image signals P₀, P₀, . . . , which represent the simple X-ray images of the chests to be subjected to the abnormal pattern candidate detection processing. Specifically, with the abnormal pattern candidate detecting apparatus, it is regarded that the adjustment images P₀′, P₀′, . . . having been selected from the plurality of the images to be subjected to the abnormal pattern candidate detection processing are normal images, and the threshold value Th for the abnormal pattern candidate detection processing is capable of being set automatically, such that only the false positives are detected as a result of the abnormal pattern candidate detection processing performed on the adjustment images P₀′, P₀′, . . . Therefore, variation in result of detection of abnormal pattern candidates due to a difference of image recording conditions is capable of being suppressed, such that an image recorded with a particular technique need not be used, and the reliability of the detection performance of the abnormal pattern candidate detection processing is capable of being enhanced.

Also, a manual operation need not be performed for a particular image recording operation, or the like, and the setting of the threshold value Th is capable of being performed as a perfectly automatic operation. Therefore, the operation efficiency of the abnormal pattern candidate detecting apparatus is capable of being enhanced.

In the aforesaid first embodiment of the abnormal pattern candidate detecting apparatus in accordance with the present invention, the threshold value Th is set in accordance with the isolated regions, which have been extracted from the entire area of each of the adjustment images P₀′, P₀′, . . . However, in the cases of the abnormal pattern candidate detection processing performed on the simple X-ray images of the chests, the problems may often occur in that the false positives representing the intersecting areas of the rib patterns are detected. The problems described above may also occur in the cases of normal images.

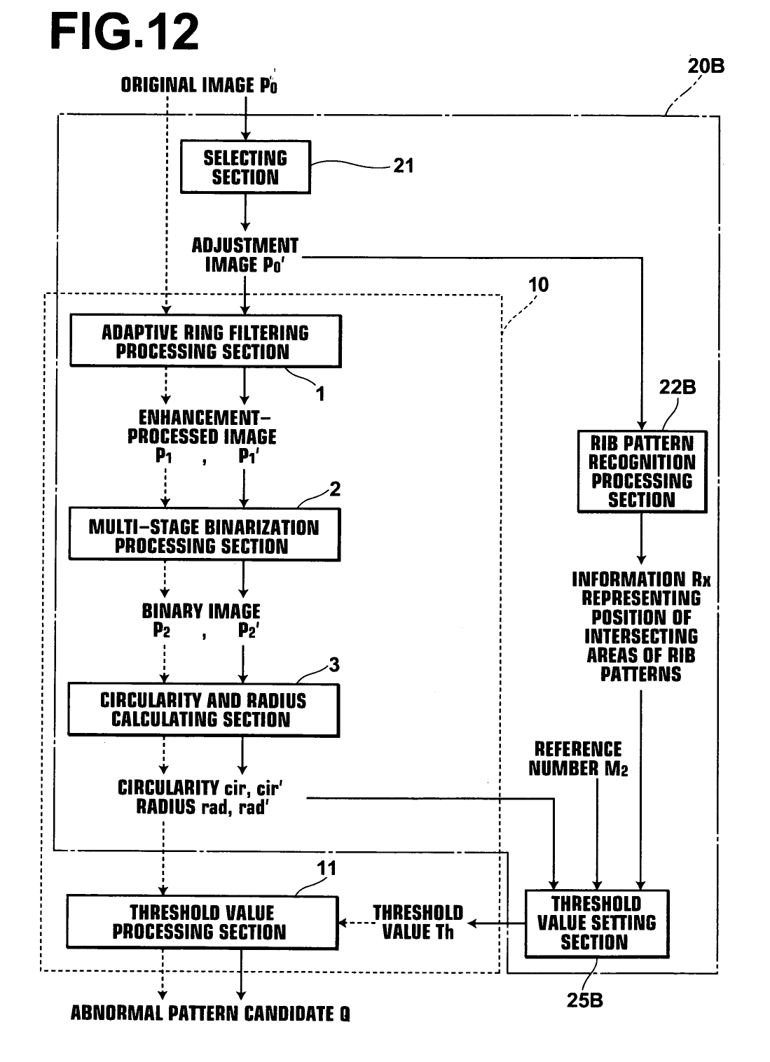

Therefore, in a second embodiment of the abnormal pattern candidate detecting apparatus in accordance with the present invention, the setting of the threshold value Th is performed with attention being paid to the isolated regions, which are located at the intersecting areas of the rib patterns, among the isolated regions having been extracted from the entire area of each of the adjustment images P₀′, P₀′, . . . FIG. 12 is a block diagram showing a constitution and a processing flow in a second embodiment of the abnormal pattern candidate detecting apparatus in accordance with the present invention. As illustrated in FIG. 12, the second embodiment of the abnormal pattern candidate detecting apparatus in accordance with the present invention is constituted basically in the same manner as that for the aforesaid first embodiment, except for the features described below. Specifically, the second embodiment of the abnormal pattern candidate detecting apparatus in accordance with the present invention is provided with a rib pattern recognition processing section 22B, which performs the processing for recognizing the rib patterns in each of the adjustment images P₀′, P₀′, . . . and which outputs information Rx, which represents the positions of the intersecting areas of the rib patterns. Also, the threshold value setting section 25A is replaced by a threshold value setting section 25B. The threshold value setting section 25B calculates the threshold value Th, which is to be used in the threshold value processing section 11, in accordance with the circularity cir′ and the radius rad′ of each of the isolated regions, the information Rx, which represents the positions of the intersecting areas of the rib patterns embedded in each of the adjustment images P₀′, P₀′, . . . , and a reference number M₂. The reference number M₂ represents the number of the abnormal pattern candidates, which are detected at the intersecting areas of the rib patterns in cases where the threshold value Th is set such that a true positive detection rate desired by a person, who views a displayed image, is acquired in the abnormal pattern candidate detection processing performed on inputted image signals representing a plurality of teacher images, in which the regions of abnormal patterns have been specified previously. Further, the selecting section 21, the rib pattern recognition processing section 22B, the adaptive ring filtering processing section 1, the multi-stage binarization processing section 2, the circularity and radius calculating section 3, and the threshold value setting section 25B together constitute parameter setting means 20B. The differences between the first and second embodiments will mainly be described hereinbelow.

The rib pattern recognition processing section 22B previously prepares a statistical model of the shape of the rib patterns having normal structures by using sample images of the chests as the teacher images. Also, the rib pattern recognition processing section 22B artificially forms the shapes of the rib patterns, which correspond to the inputted chest images, in accordance with the prepared models.

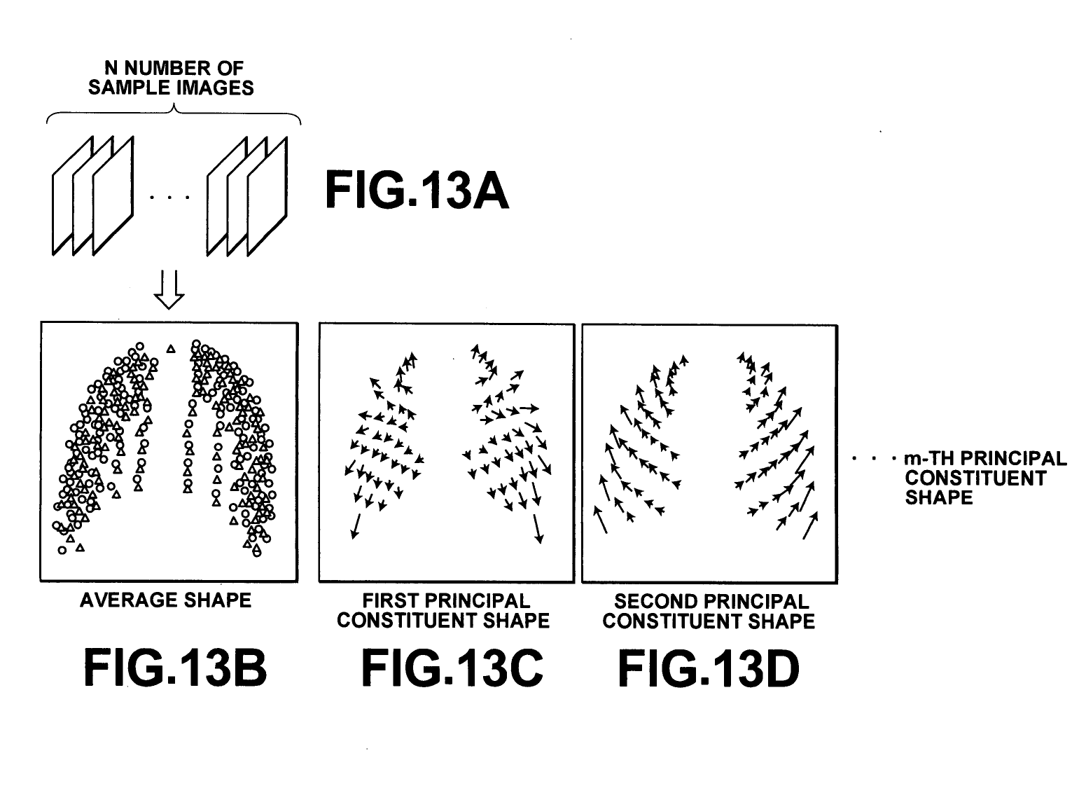

The statistical model of the shape of the rib patterns having the normal structures may be prepared in the manner described below. Specifically, firstly, as illustrated in FIG. 13A, N number of the sample images, in which the rib patterns are recorded clearly, are selected from a plurality of the chest images. Also, each of the selected sample images is displayed as a visible image, and n number (e.g., n=400) of points are specified on front rib patters and rear rib patterns embedded in the sample image in accordance with a predetermined rule and by use of a pointing device, such as a mouse device. The predetermined rule defines the order in which the plurality of the parts of the rib pattern are specified. Also, the shapes of the rib patterns (landmarks), which are represented by the thus specified points, are utilized as teacher data, and the statistical model of the shape of the rib patterns is prepared previously by use of a technique described in “Active Appearance Models (AAM)”, by T. F. Cootes et al., Proc. European Conference on Computer Vision, Vol. 2, pp. 484-498, Springer, 1998. More specifically, firstly, with respect to each of the N number of the sample images, a shape X=(x1, y1, . . . , xi, yi, . . . , xn, yn) of the rib patterns, in which the n number of the landmarks have been specified, is prepared. Also, as illustrated in FIG. 13B, an average shape Xave=(xₐᵥₑ1, yₐᵥₑ1, . . . , Xₐᵥₑi, Yₐᵥₑi, . . . , xₐᵥₑn, yₐᵥₑn) of the rib patterns is calculated from the averaging of the shapes of the rib patterns having been prepared with respect to the N number of the sample images. (In FIG. 13B, the “◯” mark represents the front rib patterns, and the “Δ” marks represents the rear rib patterns.) Thereafter, difference vectors ΔXj=Xj-Xave (where j=1, . . . , N) between the shapes X of the rib patterns embedded in the N number of the sample images and the average shape Xave of the shapes X are calculated. Further, a principal constituent analysis is made with respect to the N number of the difference vectors ΔXj (where j=1, . . . , N). With the principal constituent analysis, eigenvectors (hereinbelow referred to as the principal constituent shapes) Ps (where s=1, . . . , m) of first principal constituents to m-th principal constituents are calculated. As illustrated in FIG. 13C, in cases where the principal constituent analysis is made, the first principal constituent shape P1 appears as the constituents which spread the rib patterns in the directions indicated by the arrows in FIG. 13C. Also, as illustrated in FIG. 13D, the second principal constituent shape P2 appears as the constituents which spread the rib patterns in the directions indicated by the arrows in FIG. 13D. A model of an arbitrary shape of the rib patterns may be approximately represented by Formula (6) shown below with a linear sum of the average shape Xave and the principal constituent shapes Ps (where s=1, . . . , m). With alteration of a shape coefficient bs, various rib pattern shapes are capable of being formed through warping from the average shape.

$$X = X ave + {\sum }_{s}^{m} bsPs \qquad ( 6 )$$

wherein bs represents the shape coefficient.

Thereafter, in order for the rib pattern shape, which coincides with the rib pattern embedded in the inputted chest image, to be formed artificially, the shape coefficient bs is calculated. Specifically, a certain number of points, which are located on the rib pattern embedded in the inputted chest image, are acquired from the chest image. Also, coordinate values of the points on the rib pattern are substituted into Formula (6), and solutions of the shape coefficient bs are thereby calculated. (The solutions of the shape coefficient bs are capable of being calculated as the solutions of simultaneous equations through substitution of the same number of points as that of the shape coefficients bs into Formula (6).) As for a chest image P, in which the recorded rib pattern shape is not clear, the entire rib pattern shape is capable of being formed through substitution of the calculated shape coefficients bs into Formula (6) shown above. Also, in the cases of the chest images, the rear rib patterns are capable of being easily extracted with edge detection, and therefore the shape coefficients bs are capable of being calculated through extraction of points located on the edges of the rear rib patterns. (As for the technique described above, reference may be made to, for example, U.S. Patent Application Publication No. 20030210813.)

Alternatively, in order for the rib pattern shape, which coincides with the rib pattern embedded in the inputted chest image, to be formed artificially, a technique may be employed, wherein the edges of the rib patterns are extracted from the chest image, wherein points on the extracted rib patterns are acquired with interpolating operations, such as B spline interpolating operations, and wherein the rib pattern shape is thereby extracted.

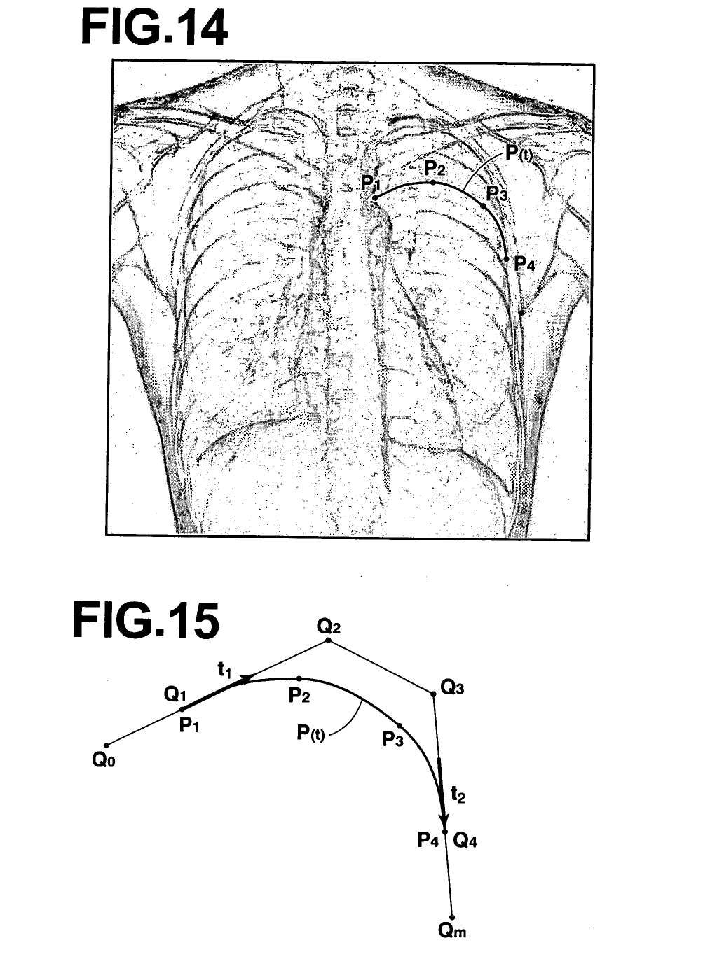

Specifically, as illustrated in FIG. 14, a plurality of points P₁, P₂, P₃, . . . , which lie on a curve representing the edge of the rib pattern having been detected from the chest image, may be extracted. Also, as illustrated in FIG. 14 and FIG. 15, a B spline curve P₍ₜ₎ for the interpolation from the points P₁, P₂, P₃, . . . is formed. An n-th order B spline curve P₍ₜ₎ may be defined by control points Qᵢ (where i=1, 2, . . . , n) and a parameter t and may be represented by Formula (7) shown below.

$$P ( t ) = {\sum }_{i = 0}^{n} {B}_{i n} ( t ) {Q}_{i} \qquad ( 7 )$$

wherein Bᵢₙ(t) represents the Bernstein polynomial.

Also, in cases where n=3, a third order B spline curve P₍ₜ₎ may be represented by Formula (8) shown below.

$$P ( t ) = [ \begin{matrix}{B}_{0} ( t ) & {B}_{1} ( t ) & {B}_{2} ( t ) & {B}_{3} ( t )\end{matrix} ] Q \\ wherein \\ Q = {[ \begin{matrix}{Q}_{0} & {Q}_{1} & {Q}_{2} & {Q}_{3}\end{matrix} ]}^{T} \\ {B}_{0} ( t ) = \frac{1}{6} {( 1 - t )}^{3} , {B}_{1} ( t ) = \frac{1}{2} {t}^{3} + {t}^{2} + \frac{2}{3} , {B}_{2} ( t ) = \frac{1}{2} {t}^{3} + \frac{1}{2} {t}^{2} + \frac{1}{2} t + \frac{1}{6} , {B}_{3} ( t ) = \frac{1}{6} {t}^{3} where 0 ≦ t ≦ 1. \qquad ( 8 )$$

Therefore, in cases where t=0 in Formula (7), Formula (9) shown below obtains.

$${P}_{i} = ( \frac{1}{6} {Q}_{i - 1} + \frac{2}{3} {Q}_{i} + \frac{1}{6} {Q}_{i + 1} ) ( i = 1 , … , m - 1 ) \qquad ( 9 )$$

wherein m represents the number of the control points.

The control points are given as illustrated in FIG. 15. A second control point Q₂ is located on a tangential line t₁ at a start point of the curve representing the edge of the rib pattern. Also, a third control point Q₃ is located on a tangential line t₂ at an end point of the curve representing the edge of the rib pattern. Therefore, control points Qᵢ (where i=1, 2, 3, . . . ) may be acquired such that the relationship described above, the positions of points Pᵢ on the curve representing the edge of the rib pattern, and the relationship of Formula (9) shown above are satisfied. (As for the acquisition of the control points, reference may be made to, for example, “Analyzing the 3D Shape and Respiratory Motion of the Ribs Using Chest X-Ray Images”, by Myint Myint Sein, et al., Medical Imaging Technology, Vol. 20, No. 6, pp. 694-702, November 200.) Points on the extracted edge may thus be acquired with the interpolating operations with the B spline curve, and the rib pattern shape may thereby be obtained.

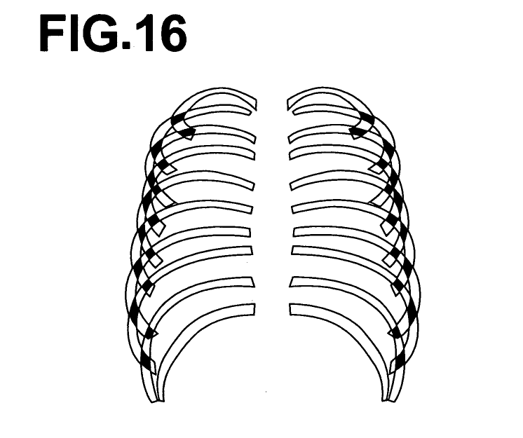

Thereafter, in cases where the rib pattern recognition processing with the AAM described above has been performed, the rib pattern recognition processing section 22B forms a binary image with binarization processing. With the binarization processing, of the rib pattern shape having been recognized, the region within the rear rib pattern shape represented by the landmark points on the rear rib pattern is assigned with a value of c₁, and the other regions are assigned with a value of 0. Also, the rib pattern recognition processing section 22B forms a binary image with the binarization processing, wherein the region within the front rib pattern shape represented by the landmark points on the front rib pattern is assigned with a value of c₂, and the other regions are assigned with a value of 0. Further, the rib pattern recognition processing section 22B forms an addition image from an operation for adding the pixel values of the corresponding pixels in the thus formed two binary images to each other. As illustrated in FIG. 16, an area, in which the pixel values become equal to (c₁+c₂), is judged as being an intersecting area of the rib patterns. The information Rx, which represents the positions of the intersecting areas of the rib patterns, is outputted from the rib pattern recognition processing section 22B. In cases where the interpolating operation processing with the B spline curve described above has been performed, an intersecting point of the obtained curves is judged as being the intersecting area of the rib patterns, and the information Rx, which represents the positions of the intersecting areas of the rib patterns, is outputted from the rib pattern recognition processing section 22B.

The threshold value setting section 25B makes a judgment as to whether each of the isolated regions in each of the binary images P₂′, P₂′, . . . is or is not located at the intersecting area of the rib patterns having been recognized by the rib pattern recognition processing section 22B. Also, the threshold value setting section 25B performs the processing described below with respect to only the isolated regions having been judged as being located at the intersecting areas of the rib patterns. Specifically, in the same manner as that in the threshold value setting section 25A in the aforesaid first embodiment, the threshold value setting section 25B sets the threshold value Th, which is to be used in the threshold value processing section 11, in accordance with the circularity cir′ and the radius rad′, such that a number of abnormal pattern candidates, which number is equal to the predetermined reference number M₂, may be detected for each image. The information representing the threshold value Th is stored in a memory of the threshold value setting section 25B.

In the same manner as that for the reference number M₁ in the aforesaid first embodiment, in order for the reference number M₂ to be obtained, the abnormal pattern candidate detection processing is performed on the inputted image signals representing the plurality of the teacher images, in which the regions of abnormal patterns have been specified previously. Also, the rib pattern recognition processing described above is performed. Further, in accordance with the results of the abnormal pattern candidate detection processing and the rib pattern recognition processing, the number of the abnormal pattern candidates, which are detected at the intersecting areas of the rib patterns in cases where the true positive detection rate desired by a person, who views a displayed image, is acquired, is counted. As in the cases of the aforesaid first embodiment, the information representing the reference number M₂ is stored previously in the memory of the image processing server.

The flow of the processing performed with the second embodiment of the abnormal pattern candidate detecting apparatus in accordance with the present invention will be described hereinbelow with reference to FIG. 12.

Firstly, the parameter setting means 20B sets the threshold value Th, which is to be used for the detection of the abnormal pattern candidates from the original images P₀, P₀, . . . to be subjected to the abnormal pattern candidate detection processing. The setting of the threshold value Th is performed in the manner described below.

(1) The selecting section 21 receives the inputted original image signals P₀, P₀, . . . , each of which represents one of the simple X-ray images of the chests having been recorded in mass medical examinations, and the like. The selecting section 21 selects the plurality of the adjustment images P₀′, P₀′, . . . at random from the inputted original images P₀, P₀, and outputs the adjustment image signals P₀′, P₀′, . . .

(2) The adaptive ring filtering processing section 1 receives the plurality of the inputted adjustment image signals P₀′, P₀′, . . . having been selected by the selecting section 21. The adaptive ring filtering processing section 1 performs the image processing with the adaptive ring filter with respect to each of the inputted images and outputs the enhancement-processed image signals P₁′, P₁′, . . . , each of which represents the enhancement-processed image corresponding to one of the adjustment images P₀′, P₀′, . . .

(3) The multi-stage binarization processing section 2 receives the inputted enhancement-processed image signals P₁′, P₁′, . . . , which have been formed by the adaptive ring filtering processing section 1. The multi-stage binarization processing section 2 performs the 39-stage binarization processing on each of the inputted images and outputs 39 kinds of the binary images P₂′, P₂′, . . . with respect to each of the enhancement-processed images P₁′, P₁′, . . .

(4) The circularity and radius calculating section 3 calculates the circularity cir′ and the radius rad′ with respect to each of the isolated regions, which are embedded in each of the binary images P₂′, P₂′, . . .

(5) The rib pattern recognition processing section 22B performs the aforesaid rib pattern recognition processing on the adjustment image signals P₀′, P₀′, . . . and outputs the information Rx, which represents the positions of the intersecting areas of the rib patterns.

(6) In accordance with the received information Rx, which represents the positions of the intersecting areas of the rib patterns, the threshold value setting section 25B makes a judgment as to whether each of the isolated regions, which are embedded in each of the binary images P₂′, P₂′, . . . , is or is not located at the intersecting area of the rib patterns. Also, in accordance with the circularity cir′ and the radius rad′ having been calculated with respect to each of the isolated regions, which have been judged as being located at the intersecting areas of the rib patterns, the threshold value setting section 25B calculates the threshold value Th for each of the circularity and the radius, such that the M₂ number of the abnormal pattern candidates are detected from one adjustment image P₀′. The information representing the threshold value Th is stored in the memory of the image processing server.

The abnormal pattern candidate detecting means 10 performs the same processing as the processing in the aforesaid first embodiment.

As described above, with the second embodiment of the abnormal pattern candidate detecting apparatus in accordance with the present invention, the parameter setting means 20B utilizes the results of the processing for recognizing the rib patterns embedded in the adjustment images P₀′, P₀′, . . . , which processing has been performed by the rib pattern recognition processing section 22B, and performs the setting of the threshold value Th with attention being paid to only the isolated regions, which are located at the intersecting areas of the rib patterns, among the isolated regions having been extracted from the entire areas of the adjustment images P₀′, P₀′, . . . In such cases, if true abnormal patterns are not present at the intersecting areas of the rib patterns in the adjustment images P₀′, P₀′, . . . , the images are capable of being regarded as being normal images regardless of whether abnormal pattern candidates have or have not been detected at the areas other than the intersecting areas of the rib patterns. Therefore, the setting of the threshold value Th suffers from less effect of true abnormal patterns than the cases where the setting of the threshold value Th is performed with attention being paid to the isolated regions having been extracted from the entire areas of the adjustment images P₀′, P₀′, . . . Accordingly, the reliability of the detection performance of the abnormal pattern candidate detection processing is capable of being enhanced even further. In cases where the proportion of the intersecting areas of the rib patterns with respect to the entire area of the chest image is taken into consideration, it is considered that the possibility of the true abnormal patterns being located at the intersecting areas of the rib patterns is lower than the possibility of the true abnormal patterns being located at the areas other than the intersecting areas of the rib patterns. Therefore, the setting of the threshold value Th, which setting is performed with attention being paid only to the intersecting areas of the rib patterns is markedly efficient.

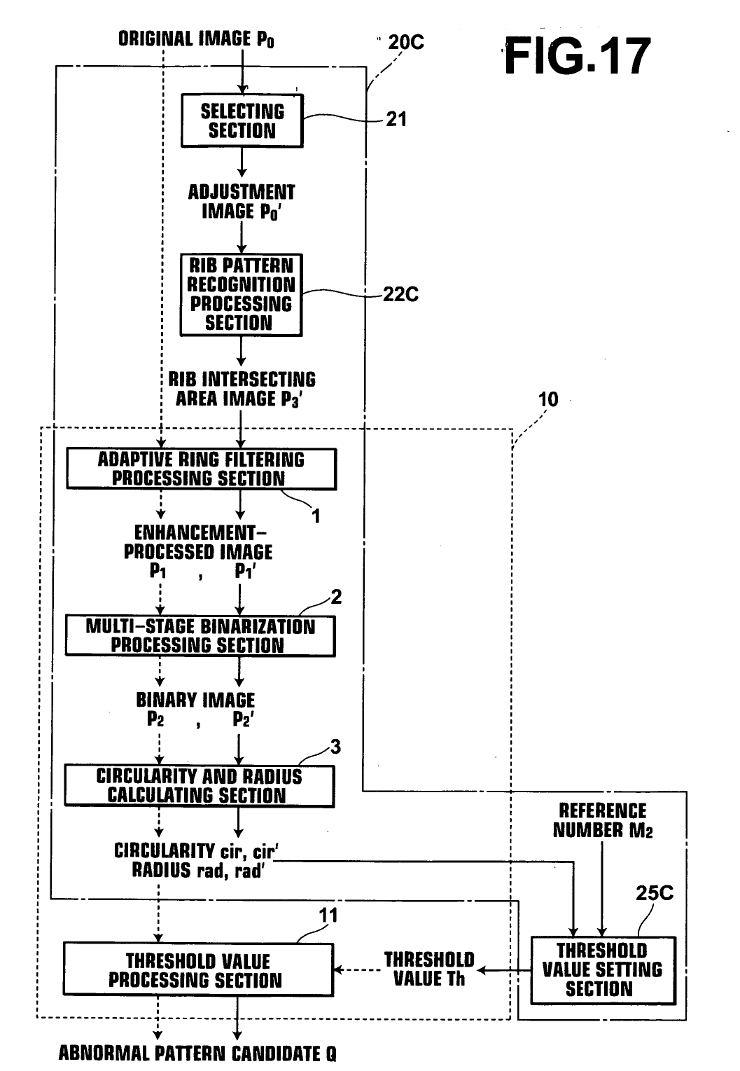

In a third embodiment of the abnormal pattern candidate detecting apparatus in accordance with the present invention, the adaptive ring filtering processing, the binarization processing, and the calculation of the circularity cir′ and the radius rad′ are performed with respect to only the intersecting areas of the rib patterns embedded in the adjustment images P₀′, P₀′, . . . Also, the setting of the threshold value Th is performed in accordance with the results of the calculation. FIG. 17 is a block diagram showing a constitution and a processing flow in a third embodiment of the abnormal pattern candidate detecting apparatus in accordance with the present invention. As illustrated in FIG. 17, the third embodiment of the abnormal pattern candidate detecting apparatus in accordance with the present invention is constituted basically in the same manner as that for the aforesaid second embodiment, except for the features described below. Specifically, in the third embodiment of the abnormal pattern candidate detecting apparatus in accordance with the present invention, the rib pattern recognition processing section 22B in the second embodiment is replaced by a rib pattern recognition processing section 22C for performing the processing, wherein the rib patterns embedded in each of the adjustment images P₀′, P₀′, . . . are recognized, and forming rib intersecting area images P₃′, P₃′, . . . representing the intersecting areas of the rib patterns. Also, the threshold value setting section 25B in the second embodiment is replaced by a threshold value setting section 25C for calculating the threshold value Th, which is to be used in the threshold value processing section 11, in accordance with the circularity cir₁ and the radius rad′, which have been calculated in accordance with each of the rib intersecting area images P₃′, P₃′, . . . , and in accordance with the reference number M₂ as in the aforesaid second embodiment. Further, the selecting section 21, the rib pattern recognition processing section 22C, the adaptive ring filtering processing section 1, the multi-stage binarization processing section 2, the circularity and radius calculating section 3, and the threshold value setting section 25C together constitute parameter setting means 20C. The differences between the second and third embodiments will mainly be described hereinbelow.

In the same manner as that in the rib pattern recognition processing section 22B in the aforesaid second embodiment, the rib pattern recognition processing section 22C performs the processing for recognizing the rib patterns embedded in each of the inputted simple X-ray images of the chests. Thereafter, the rib pattern recognition processing section 22C forms the rib intersecting area images P₃′, P₃′, . . . , each of which represents the intersecting areas of the rib patterns. Since a plurality of the intersecting areas of the rib patterns are embedded in one simple X-ray image of the chest, a plurality of the rib intersecting area images P₃′, P₃′, . . . are formed.

The threshold value setting section 25C sets the threshold value Th, which is to be used in the threshold value processing section 11, in accordance with the circularity cir′ and the radius rad′ of each of the isolated regions in each of the binary images P₂′, P₂′, . . . , the circularity cir′ and the radius rad′ having been calculated by the circularity and radius calculating section 3, such that a number of abnormal pattern candidates, which number is equal to the predetermined reference number M₂, may be detected for each image. The information representing the threshold value Th is stored in a memory of the threshold value setting section 25C. The reference number M₂ is obtained in the same manner as that in the aforesaid second embodiment.

The flow of the processing performed with the third embodiment of the abnormal pattern candidate detecting apparatus in accordance with the present invention will be described hereinbelow with reference to FIG. 17.

Firstly, the parameter setting means 20C sets the threshold value Th, which is to be used for the detection of the abnormal pattern candidates from the original images P₀, P₀, . . . to be subjected to the abnormal pattern candidate detection processing. The setting of the threshold value Th is performed in the manner described below.

(1) The selecting section 21 receives the inputted original image signals P₀, P₀, . . . , each of which represents one of the simple X-ray images of the chests having been recorded in mass medical examinations, and the like. The selecting section 21 selects the plurality of the adjustment images P₀′, P₀′, . . . at random from the inputted original images P₀, P₀, . . . and outputs the adjustment image signals P₀′, P₀′, . . .

(2) The rib pattern recognition processing section 22C performs the rib pattern recognition processing on each of the adjustment image signals P₀′, P₀′, . . . and outputs the image signals representing the rib intersecting area images P₃′, P₃′, . . .

(3) The adaptive ring filtering processing section 1 receives the inputted image signals representing the rib intersecting area images P₃′, P₃′, . . . The adaptive ring filtering processing section 1 performs the image processing with the adaptive ring filter with respect to each of the inputted images and outputs the enhancement-processed image signals P₁′, P₁′, . . . , each of which represents the enhancement-processed image corresponding to one of the rib intersecting area images P₃′, P₃′, . . .

(4) The multi-stage binarization processing section 2 receives the inputted enhancement-processed image signals P₁′, P₁′, . . . , which have been formed by the adaptive ring filtering processing section 1. The multi-stage binarization processing section 2 performs the 39-stage binarization processing on each of the inputted images and outputs 39 kinds of the binary images P₂′, P₂′, . . . with respect to each of the enhancement-processed images P₁′, P₁′, . . .

(5) The circularity and radius calculating section 3 calculates the circularity cir′ and the radius rad′ with respect to each of the isolated regions, which are embedded in each of the binary images P₂′, P₂′, . . .

(6) In accordance with the circularity cir′ and the radius rad′ having been calculated with respect to each of the isolated regions, which are embedded in each of the binary images P₂′, P₂′, . . . , the threshold value setting section 25C calculates the threshold value Th for each of the circularity and the radius, such that the M₂ number of the abnormal pattern candidates are detected from the intersecting areas of the rib patterns embedded in one adjustment image P₀′. The information representing the threshold value Th is stored in the memory of the image processing server.

The abnormal pattern candidate detecting means 10 performs the same processing as the processing in the aforesaid first embodiment.

As described above, with the third embodiment of the abnormal pattern candidate detecting apparatus in accordance with the present invention, the parameter setting means 20C utilizes the results of the processing for recognizing the rib patterns embedded in the adjustment images P₀′, P₀′, . . . , which processing has been performed by the rib pattern recognition processing section 22C. Also, the parameter setting means 20C performs the adaptive ring filtering processing, the binarization processing, and the calculation of the circularity cir′ and the radius rad′ with respect to only the intersecting areas of the rib patterns embedded in the adjustment images P₀′, P₀′, . . . and in the same manner as that in the aforesaid second embodiment. Further, the parameter setting means 20C sets the threshold value Th in accordance with the results of the calculation. Therefore, with the third embodiment, the same effects as those with the aforesaid second embodiment are capable of being obtained. Also, with the third embodiment, wherein the adaptive ring filtering processing, the binarization processing, and the calculation of the circularity cir′ and the radius rad′ are performed on only the rib intersecting area images P₃′, P₃′, . . . , which are the parts of each of the adjustment images P₀′, P₀′, . . . , the processing loads are capable of being kept lighter than the cases wherein the processing described above is performed on the entire area of each of the adjustment images P₀′, P₀′, . . .

In each of the aforesaid first, second, and third embodiments, each of the threshold value setting sections 25A, 25B, and 25C performs the setting of the threshold value Th in accordance with the information representing the average number of false positives per image or the number of the abnormal pattern candidates having been detected at the intersecting areas of the rib patterns, the information having been obtained from the results of the abnormal pattern candidate detection processing, or the like, performed on the data on the plurality of the teacher images, in which the regions of the abnormal patterns have been specified previously. The same effects are capable of being obtained in cases where a different setting technique is employed.

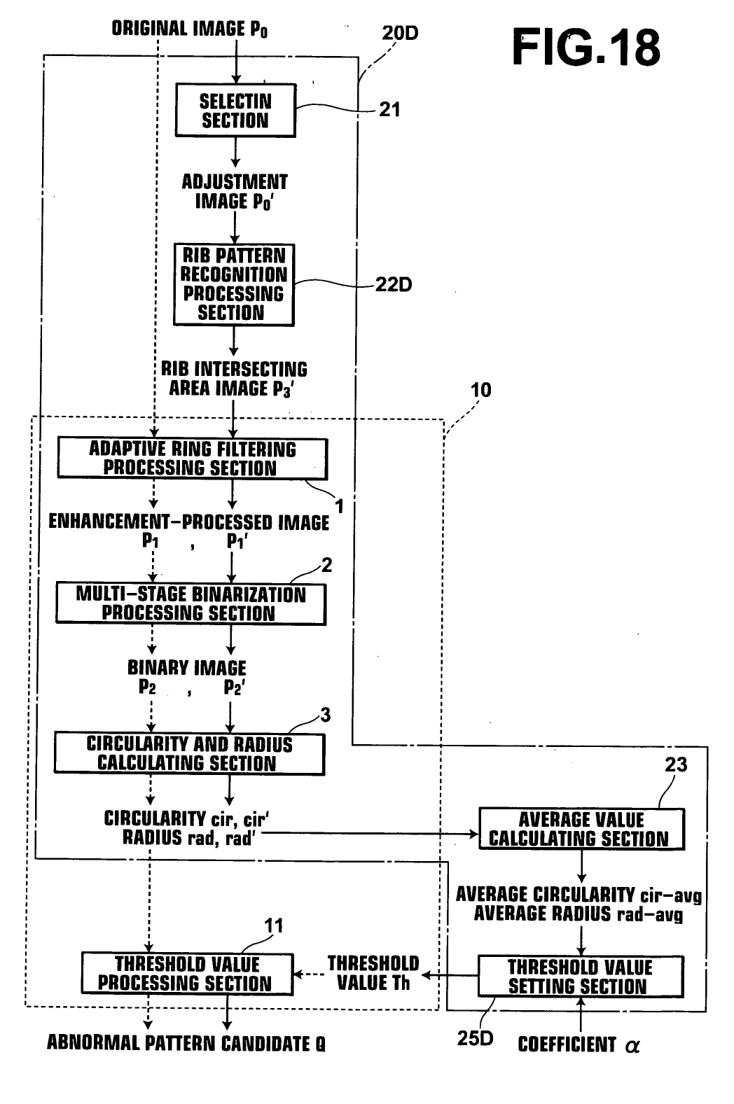

For example, in a fourth embodiment of the abnormal pattern candidate detecting apparatus in accordance with the present invention, the processing for setting the threshold value Th in the aforesaid third embodiment is altered. FIG. 18 is a block diagram showing a constitution and a processing flow in a fourth embodiment of the abnormal pattern candidate detecting apparatus in accordance with the present invention. As illustrated in FIG. 18, the fourth embodiment of the abnormal pattern candidate detecting apparatus in accordance with the present invention is constituted basically in the same manner as that for the aforesaid third embodiment, except for the features described below. Specifically, the fourth embodiment of the abnormal pattern candidate detecting apparatus in accordance with the present invention further comprises an average value calculating section 23 for calculating an average value cir-avg of the values of the circularity cir′ of the isolated regions, which values have been calculated in accordance with the rib intersecting area images P₃′, P₃′, . . . , and an average value rad-avg of the values of the radius rad′ of the isolated regions, which values have been calculated in accordance with the rib intersecting area images P₃′, P₃′, . . . Also, the threshold value setting section 25C in the aforesaid third embodiment is replaced by a threshold value setting section 25D for multiplying each of the thus calculated average value cir-avg and the thus calculated average value rad-avg by a predetermined coefficient α (e.g., α=0.9), and thereby calculating the threshold value Th. Further, the selecting section 21, a rib pattern recognition processing section 22D, the adaptive ring filtering processing section 1, the multi-stage binarization processing section 2, the circularity and radius calculating section 3, the average value calculating section 23, and the threshold value setting section 25D together constitute parameter setting means 20D. The rib pattern recognition processing section 22D has the same functions as the functions of the rib pattern recognition processing section 22C.

In the fourth embodiment, the parameter setting means 20D sets the threshold value Th, which is to be used for the detection of the abnormal pattern candidates from the original images P₀, P₀, . . . to be subjected to the abnormal pattern candidate detection processing. The setting of the threshold value Th is performed in the manner described below.

(1) The selecting section 21 receives the inputted original image signals P₀, P₀, . . . , each of which represents one of the simple X-ray images of the chests having been recorded in mass medical examinations, and the like. The selecting section 21 selects the plurality of the adjustment images P₀′, P₀′, . . . at random from the inputted original images P₀, P₀, . . . and outputs the adjustment image signals P₀′, P₀′,

(2) The rib pattern recognition processing section 22D performs the rib pattern recognition processing on each of the adjustment image signals P₀′, P₀′, . . . and outputs the image signals representing the rib intersecting area images P₃′, P₃′, . . .

(3) The adaptive ring filtering processing section 1 receives the inputted image signals representing the rib intersecting area images P₃′, P₃′, . . . The adaptive ring filtering processing section 1 performs the image processing with the adaptive ring filter with respect to each of the inputted images and outputs the enhancement-processed image signals P₁′, P₁′, . . . , each of which represents the enhancement-processed image corresponding to one of the rib intersecting area images P₃′, P₃′, . . .

(4) The multi-stage binarization processing section 2 receives the inputted enhancement-processed image signals P₁′, P₁′, . . . , which have been formed by the adaptive ring filtering processing section 1. The multi-stage binarization processing section 2 performs the 39-stage binarization processing on each of the inputted images and outputs 39 kinds of the binary images P₂′, P₂′, . . . with respect to each of the enhancement-processed images P₁′, P₁′, . . .

(5) The circularity and radius calculating section 3 calculates the circularity cir′ and the radius rad′ with respect to each of the isolated regions, which are embedded in each of the binary images P₂′, P₂′, . . .

(6) The average value calculating section 23 calculates the average value cir-avg of the values of the circularity cir′ of the isolated regions and the average value rad-avg of the values of the radius rad′ of the isolated regions.

(7) The threshold value setting section 25D multiplies each of the average value cir-avg and the average value rad-avg by the coefficient α, which has been set previously, and thereby calculates the threshold value Th for each of the circularity and the radius. The information representing the threshold value Th is stored in the memory of the image processing server. The coefficient α is the proportion of the threshold value of each of the circularity and the radius, which threshold value is associated with the cases wherein the number of the abnormal pattern candidates detected from the intersecting areas of the rib patterns embedded in each of the plurality of the teacher images having the previously specified regions of abnormal patterns becomes equal to the predetermined reference number M₂, with respect to each of the average value of the circularity and the average value of the radius, which average values are obtained from the processing of (1) through (6) described above performed on the aforesaid teacher images.

The abnormal pattern candidate detecting means 10 performs the same processing as the processing in the aforesaid first embodiment.

In each of the second, third, and fourth embodiments described above, the rib pattern recognition processing section 22B, 22C, or 22D automatically recognizes the rib patterns. Alternatively, each of the adjustment images P₀′, P₀′, . . . may be displayed on a display screen, and the person, who views a displayed image, may manually point the intersecting areas of the rib patterns by use of a mouse device, or the like. Also, the person, who views a displayed image, may collate the positions of the detected abnormal pattern candidates and the intersecting areas of the rib patterns with each other and may thus count the abnormal pattern candidates located at the intersecting areas of the rib patterns.

As a modification of each of the aforesaid embodiments, it is possible to constitute a remote monitoring system for monitoring the detection performance of each of the abnormal pattern candidate detecting apparatuses located at a plurality of diagnosis stations. Specifically, information representing the average value of the number of the abnormal pattern candidates, which have been detected at the isolated regions or the intersecting areas of the rib patterns in all of the original images P₀, P₀, . . . to be subjected to the abnormal pattern candidate detection processing or the adjustment images P₀′, P₀′, . . . , may be sent from each of the abnormal pattern candidate detecting apparatuses into a monitoring terminal through a network, such as the Internet. Also, in cases where the average value having been sent from a certain abnormal pattern candidate detecting apparatus is outside a predetermined range, a threshold value correcting command may be given manually or automatically from the monitoring terminal to the certain abnormal pattern candidate detecting apparatus. In accordance with the received threshold value correcting command, the abnormal pattern candidate detecting apparatus may update the threshold value Th in the same manner as that in each of the aforesaid embodiments. Alternatively, in lieu of the threshold value correcting command being given from the monitoring terminal, each of the abnormal pattern candidate detecting apparatuses may detect the aforesaid average value falling outside the predetermined range and automatically correct the threshold value Th. Also, only the log information representing the execution of the correction of the threshold value Th may be sent from each of the abnormal pattern candidate detecting apparatuses into the monitoring terminal. In such cases, it is sufficient for the monitoring operator to monitor the log concerning the results of the abnormal pattern candidate detection or the results of the correction made with the abnormal pattern candidate detecting apparatuses. The monitoring operator is thus capable of managing the detection performance of each of the abnormal pattern candidate detecting apparatuses.

What is claimed is:

1. An abnormal pattern candidate detecting method, in which abnormal pattern candidate detection processing using a predetermined processing parameter is performed on each of inputted image signals representing a plurality of medical images of objects, and in which abnormal pattern candidates embedded in each of the medical images are thereby detected, the method comprising the steps of, before the abnormal pattern candidate detection processing on each of the inputted image signals representing the plurality of the medical images:
i) performing at least part of the abnormal pattern candidate detection processing on an inputted image signal representing an adjustment image, which has been selected from the plurality of the medical images, and
ii) setting the predetermined processing parameter in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion.

2. An abnormal pattern candidate detecting apparatus, comprising:
i) abnormal pattern candidate detecting means for performing abnormal pattern candidate detection processing using a predetermined processing parameter on each of inputted image signals representing a plurality of medical images of objects, and thereby detecting abnormal pattern candidates embedded in each of the medical images,
ii) parameter setting means for:
performing at least part of the abnormal pattern candidate detection processing on an inputted image signal representing an adjustment image, which has been selected from the plurality of the medical images, and
setting the predetermined processing parameter in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion,
the abnormal pattern candidate detecting means performing the abnormal pattern candidate detection processing on each of the inputted image signals representing the plurality of the medical images and by use of the predetermined processing parameter, which has been set by the parameter setting means.

3. An apparatus as defined in claim 2 wherein a plurality of adjustment images are selected from the plurality of the medical images to be subjected to the abnormal pattern candidate detection processing.

4. An apparatus as defined in claim 2 wherein the objects are the chests of human bodies,
the parameter setting means further performs processing for recognizing rib patterns embedded in the adjustment image, the parameter setting means performs at least part of the processing for detecting the abnormal pattern candidates at least at the intersecting areas of the rib patterns having been recognized, and
the parameter setting means sets the predetermined processing parameter in accordance with the results of the at least part of the processing for detecting the abnormal pattern candidates such that the number of the abnormal pattern candidates detected at the intersecting areas of the rib patterns satisfies the predetermined criterion.

5. An apparatus as defined in claim 2 wherein the predetermined criterion is a criterion having been set such that the number of the abnormal pattern candidates, which are detected from the adjustment image, coincides with an average number of false positives per image,
the average number of false positives per image having been obtained in cases where the predetermined processing parameter is set such that a true positive detection rate desired by a person, who views a displayed image, is acquired in the abnormal pattern candidate detection processing performed on inputted image signals representing a plurality of teacher images, in which the regions of abnormal patterns have been specified previously.

6. An apparatus as defined in claim 5 wherein the predetermined processing parameter is a detection threshold value in the abnormal pattern candidate detection processing, and
the parameter setting means sets the detection threshold value such that the number of the abnormal pattern candidates, which are detected from an entire area of the adjustment image or a specific area of interest in the adjustment image, coincides with the average number of false positives per image.

7. An apparatus as defined in claim 2 wherein the predetermined processing parameter is a detection threshold value in the abnormal pattern candidate detection processing, and
the parameter setting means sets a value obtained from a calculation, in which an average value of a feature measure having been calculated with respect to an entire area of the adjustment image or a specific area of interest in the adjustment image is multiplied by a predetermined ratio, as the detection threshold value.

8. An apparatus as defined in claim 2 wherein the parameter setting means sets a coefficient of a mathematical formula, which coefficient acts as the processing parameter, such that an average value of a feature measure having been calculated with respect to an entire area of the adjustment image or a specific area of interest in the adjustment image coincides with the average value of the feature measure having been calculated in cases where the coefficient of the mathematical formula is set such that a,true,positive detection rate desired by a person, who views a displayed image, is acquired in the abnormal pattern candidate detection processing performed on inputted image signals representing a plurality of teacher images, in which the regions of abnormal patterns have been specified previously.

9. An apparatus as defined in claim 4 wherein the predetermined criterion is a criterion having been set such that the number of the abnormal pattern candidates, which are detected at the intersecting areas of the rib patterns embedded in the adjustment image, coincides with the number of the abnormal pattern candidates having been detected at the intersecting areas of the rib patterns in cases where the predetermined processing parameter is set such that a true positive detection rate desired by a person, who views a displayed image, is acquired in the abnormal pattern candidate detection processing performed on inputted image signals representing a plurality of teacher images, in which the regions of abnormal patterns have been specified previously.

10. A computer readable recording medium, on which a computer program for causing a computer to execute an abnormal pattern candidate detecting method has been recorded and from which the computer is capable of reading the computer program, the abnormal pattern candidate detecting method comprising performing abnormal pattern candidate detection processing using a predetermined processing parameter on each of inputted image signals representing a plurality of medical images of objects, and thereby detecting abnormal pattern candidates embedded in each of the medical images,
wherein the computer program comprises the procedures for, before the abnormal pattern candidate detection processing on each of the inputted image signals representing the plurality of the medical images:
i) performing at least part of the abnormal pattern candidate detection processing on an inputted image signal representing an adjustment image, which has been selected from the plurality of the medical images, and
ii) setting the predetermined processing parameter in accordance with the results of the at least part of the abnormal pattern candidate detection processing having been performed on the inputted image signal representing the adjustment image, such that the number of the abnormal pattern candidates, which are detected with the abnormal pattern candidate detection processing performed on the inputted image signal representing the adjustment image, satisfies a predetermined criterion.
